(19) United States
(12) Patent Application Publication
(10) Pub. No.: US 2010/0143676 A1
(43) Pub. Date: Jun. 10, 2010

(54) TRANSPARENT COMPOSITIONS AND LAMINATES

(75) Inventors: Stephen F. Hahn, Midland, MI (US); Henry G. Heck, Lake Jackson, TX (US); Pankaj Gupta, Midland, MI (US); Steven R. Jenkins, Clare, MI (US); Seema V. Karande, Pearland, TX (US); Shaun Parkinson, Tarragona (ES); Jesus Nieto, Cambrils (ES); Rajen M. Patel, Lake Jackson, TX (US); Stephen J. Skapik, III, Columbus, OH (US)

Correspondence Address: The Dow Chemical Company, P.O. BOX 1967, Midland, MI, 48641, US

(73) Assignee: DOW GLOBAL TECHNOLOGIES INC., Midland, MI (US)

(21) Appl. No.: 12/440,693

(22) PCT Filed: Sep. 17, 2007
(86) PCT No.: PCT/US2007/020102

§ 371 Date: Dec. 23, 2009

Related U.S. Application Data
(60) Provisional application No. 60/845,947, filed on Sep. 20, 2006.

(51) Int. Cl. B32B 7/02; B32B 27/32; B32B 37/00

(52) U.S. Cl. 428/212; 428/343; 156/308.2

(57) ABSTRACT

The invention includes an interlayer film and composition comprising a polymer composition obtainable from (a) at least one low crystallinity propylene polymer, and at least one (b) internal adhesion enhancer, (c) at least one clarity enhancer or (d), more preferably, both (b) and (c). The invention also includes a process of preparing a film comprising (a) supplying at least one first component, a low crystallinity propylene polymer, (b) supplying at least one second component, selected from at least one an internal adhesion enhancer, at least one clarity enhancer or a combination thereof; and, (d) admixing the first and second components and optional additives. Additionally, the invention includes a process of making a laminate comprising steps of (a) positioning at least one layer of the interlayer film directly adjacent to at least one layer of substrate (b) applying sufficient heat or other energy to result in softening of the interlayer directly adjacent the substrate with simultaneous application of sufficient pressure to press polymer into intimate contact with substrate. The invention also includes laminates and articles comprising the composition or film of the invention or a combination thereof.

### CROSS REFERENCE STATEMENT

This application claims the benefit of U.S. Provisional Application No. 60/845,947 filed Sep. 20, 2006.

### BACKGROUND

The invention relates to compositions of thermoplastic polymers, films thereof, laminates of the films and processes for making the laminates as well as laminates having interlayer films with certain optical qualities. The compositions are useful as films, preferably transparent films. The films are useful in laminates, for instance in laminates having at least one film layer and at least one layer of mineral or plastic glass.

In many applications where glass or other rigid material is laminated to a polymer film, the film should provide penetration resistance as well as clarity and a strong bond to the glass. A strong bond to the glass is needed to avoid scattering of glass pieces if the glass breaks as well as to maintain visual clarity that is lost if delamination occurs, as exemplified by the optically observable distortion that occurs when bubbles form in glass laminates. Clarity is usually needed in applications where vision or other light transmission through the laminate is desirable such as in windows, including vehicular windows and in applications such as photovoltaic cells where maximum light transmission is desirable for maximum conversion of the light to electricity. Penetration resistance is also needed in applications like architectural and vehicular windows and photovoltaic cells because of potential exposure to impact such as hail and other weather related conditions as well as human activity from projectiles, wrecks, and other insults. Although the polymer film is appropriate for bonding to one or more rigid sheets, the term “interlayer” is used herein because commonly such films are used between two sheets or a sheet and another material such as another film or a solar cell, which sheet, film or other material will be referred to herein simply as a layer.

The interlayer is usually a polymer film exhibiting adhesiveness to the glass or layer. Polymer interlayers for mineral and plastic clear layers advantageously possess a combination of characteristics including as many as possible of very high clarity (low haze), high impact and penetration resistance, good adhesion to glass, lower moisture absorption than PVB or EVA, high moisture resistance, and resistance to changes when weathered. Typical commercial interlayers are based, for instance, on polyvinyl butyral (PVB), polyurethane (PU), or ethylene copolymers such as ethylenevinylacetate (EVA), and ethylene/acrylic acid ionomers, primarily PVB.

PVB, however, has several disadvantages. PVB is moisture sensitive. Increased moisture in interlayer films results in increased haze and may cause bubble formation in the final laminated flat glass product. This problem is noticed particularly around the edges of laminates and increases over time. Some compensation is accomplished by using special handling techniques. Another disadvantage of PVB is the need for a plasticizer in the film formulation to improve impact, tear and penetration resistance and adhesion to glass. Plasticizers tend to migrate and ultimately may result in delamination. Another disadvantage is that PVB film has an impact resistance that is temperature dependent and reduced at low temperatures.

Other materials, even olefin based materials, have long been suggested for use as safety glass interlayers. In U.S. Pat. No. 4,303,739, Beckmann suggested using ethylene or propylene polymers having a Shore A hardness of 40-98, preferably 50-95 but found that large quantities of plasticizers were necessary. In fact, success was found only with the use of what were referred to as “internal plasticizers.” These were monomers like vinyl acetate interpolymerized with ethylene or propylene. Beckman taught using various organofunctional silane coupling agents to improve adhesion to glass. While using them as a primer on glass was preferred, he also taught that mixing the silanes with the interlayer polymer as taught in DE 2410153 and U.S. Pat. No. 4,144,376 was effective. Ethylene vinyl acetate (EVA) continued to be used, often with peroxide crosslinking such as was taught in U.S. Pat. No. 4,614,781 and U.S. Pat. No. 5,352,530 where they were taught to reduce haze. Even with the combination of coupling agents and peroxides, as taught in U.S. Pat. No. 4,600,627, and use of various additives such as UV stabilizers or absorbers and IR blockers, EVA still exhibited problems such as deterioration on prolonged exposure to sunlight that resulted in darkening and resulting loss of clarity and light transmission. Additionally, EVA interlayers are prone to moisture absorption, and do not provide sufficient impact resistance for some applications. Furthermore, EVA interlayers have the disadvantage of higher density with increased elasticity. To achieve similar flexural modulus to that of PVB, the polymer must contain around 28% by weight vinyl acetate which results in a density of around 0.951 grams per cubic centimeter compared to a straight polyethylene density of 0.92 grams per cubic centimeter. When metallocene catalyzed polyethylenes, especially the substantially linear ethylene polymers catalyzed using constrained geometry catalysts, became available with the low Shore A hardness taught by Beckmann, a low flexural modulus or stiffness that made plasticizers, especially internal plasticizers, unnecessary, and were disclosed as having clarity in such references as U.S. Pat. No. 5,332,706, U.S. Pat. No. 5,281,679, U.S. Pat. No. 5,206,075, EP 206794, U.S. Pat. No. 5,427,807, U.S. Pat. No. 5,380,810 and U.S. Pat. No. 5,272,236, they were proposed for use in interlayer films in U.S. Pat. No. 5,792,560. However, these interlayers had limited impact strength or penetration resistance and could not be successfully commercialized for use in applications like safety glass. Intermediate layers such as polyester, polyvinyl chloride, polyvinylidene chloride, polyethylene, ethylene-vinyl acetate copolymer, saponified ethylene-vinyl acetate copolymer, polymethyl methacrylate, polyvinyl butyral, ethylene-ethyl acrylate copolymer, ethylene-methyl acrylate copolymer, ethylene-methacrylate copolymer crosslinked with metal ions, polystyrene, polyurethane, polycarbonate, cellophane and the like have been proposed for use between two EVA layers for improved properties like penetration resistance, for instance in U.S. Pat. No. 4,600,627. In photovoltaic cell encapsulants, that is, the layer between a transparent superstrate or top layer and the solar cell, there has been a similar progression from EVA to substantially linear ethylene polymers; see U.S. Pat. No. 6,599,230, U.S. Pat. No. 6,586,271, U.S. Pat. No. 6,320,116, and WO 2004/0055908. Propylene polymers have generally not been pursued as possible interlayers because they have more haze than would be desirable in interlayers and also frequently exhibit disadvantages of poor low temperature toughness and high flexural modulus or stiffness.

It would be desirable to have a film useful as a safety glass interlayer that would have a penetration resistance greater than that of substantially linear ethylene polymers as disclosed in U.S. Pat. No. 5,792,560, preferably at least as high as PVB at the same thickness, while avoiding its sensitivity to moisture as indicated by it tendency to turn hazy at the edges after a one hour immersion in boiling water. Advantageously, when used with transparent layers, the interlayer would also have one or more of high clarity (low haze), with good adhesion to glass, and optionally the ability to block UV-light transmittance.

Some applications are also noise sensitive. For instance, safety glass used in cars preferably absorb at least as much sound as a single pane of the same thickness would or do not result in echoes or sound sharpness greater than that of glass alone, especially within the range of frequencies detectable by the human ear, that is, about 400-15,000 Hertz, with the most critical range falling between 500 to 10,000 Hertz. An acoustical barrier glazing has been traditionally understood to be a barrier providing a level of acoustic comfort within the vehicle or building comparable to the level of acoustic comfort provided by a conventional monolithic glass barrier for a given intensity and quality of environmental noise. Glass (for instance, soda-lime-silicate mineral glass) provides a good acoustical barrier and is most effective at a total glazing thickness of at least about 10 mm; however, a glass thickness of 3 to 5 mm is now considered more preferable for automobile side lights so as to minimize the contribution of the glazing to the overall weight of the automobile. Automotive side lights have been made with double glass panes separated by an air space to achieve superior acoustical barrier properties, but such a construction is generally unacceptable in automotive glazing due to mechanical barrier (safety and security) and weight considerations. Standards and measurements for acoustic barriers in automobiles are known to those skilled in the art for instance as disclosed in such references as U.S. Pat. No. 6,432,522, U.S. Pat. No. 5,368,917, U.S. Pat. No. 5,729,658 especially for an articulation index, and U.S. Pat. No. 5,464,659 for loudness, which are hereby incorporated by reference to the fullest extent allowed under the laws of the jurisdiction. It would be desirable for a safety glass laminate for use in vehicles to have at least one to as many as possible of the following an acoustical barrier insulating capacity at least equivalent to that of a 3.85 mm thick monolithic pane of glass, an Articulation Index value of less than 64.2% at 50 to 10,000 Hz, a sharpness value of less than 150 at 50 to 10,000 Hz. The acoustic barrier is preferably better than glass of the same thickness, more preferably better than that achieved by a standard PVB interlayer of the same thickness with the same glass.

Alternatively, it would be desirable to have a method of making a laminate, particularly a laminate of at least one glass layer and at least one film layer, which does not require the lamination conditions required by PVB. Such a method would preferably also result in a laminate with a haze less than 5%, more preferably less than 1%, and most preferably less than 0.5% as measured by ASTM D570. Typical autoclave conditions required by PVB include 110-185° C. for periods up to several hours with pressures up to about 700-1000 kPa during at least part of the time. Such conditions are very expensive and may result in recrystallization of the interlayer which could result in additional haze if not otherwise controlled, such as through crosslinking.

### SUMMARY OF THE INVENTION

This invention comprises a film useful as an interlayer, a composition useful to make the film, and a laminate comprising the film and at least one rigid or optically transparent substrate or combination thereof. The composition is obtainable from (a) at least one low crystallinity propylene polymer, and at least one (b) internal adhesion enhancer, (c) at least one clarity enhancer or (d), more preferably, both (b) and (c). The term “obtainable from” is used to designate a composition comprising the listed components (that is, (a), (b), (c), and (d)) or the product of a composition comprising the listed components after one or more of the components is reacted. For instance, component (a) and a crosslinking agent as (c) may react to form a crosslinked low crystallinity propylene polymer. Such a composition is referred to hereinafter as the interlayer composition. The film comprises such a composition or at least one low crystallinity propylene polymer, and at least one adhesion enhancer, which may be internal or external.

The invention also includes a process of preparing a film comprising (a) supplying at least one first component, a low crystallinity propylene polymer, (b) supplying at least one second component, selected from at least one an internal adhesion enhancer, at least one clarity enhancer or a combination thereof; and, (d) admixing the first and second components and optional additives.

Additionally, the invention includes a process of making a laminate comprising steps of (a) positioning at least one layer of the interlayer film directly adjacent to at least one layer of substrate (b) applying sufficient heat or other energy to result in softening of the interlayer directly adjacent the substrate with simultaneous application of sufficient pressure to press polymer into intimate contact with substrate.

Additionally the invention includes laminates and articles including at least one film or composition of the invention, particularly where the laminate includes at least one first substrate that is preferably rigid or optically transparent, most preferably both, and most preferably includes at least one second substrate which is preferably rigid, optically transparent or electronic or a combination thereof such as safety glass or photovoltaic cells.

### BRIEF DESCRIPTION OF THE DRAWINGS

There are no drawings.

### DETAILED DESCRIPTION OF THE INVENTION

### Definitions

The term “interlayer” is used herein to refer a layer of material useful between two other layers, advantageously of a composition different from that of the interlayer, and optionally different from each other. The other layer or layers are preferably, but not necessarily rigid and often have some degree of transparency such as glass. In a preferred embodiment an interlayer is a film. Use of the term “interlayer,” however, does not limit the utility of such a film or scope of the invention to use between other layers. The interlayer film is also useful laminated to one such other layer. The term interlayer film is used herein whether or not there are additional layers such as tie layers between an interlayer film and an outer layer, for instance glass.

The term “clarity” as used herein refers to transmission of visible light when the haze of a material is less than about 10 percent, preferably less than about 5 percent. Clarity is considered high when light transmission is higher than about 60 percent, preferably higher than 70 percent, more preferably higher than 75 percent, and most preferably higher than 80 percent.

Light transmission is a measurement of the light transmitted through an object, in the practice of this invention through a film or laminate, for instance. It is measured according to the procedures of ASTM D1003.

The term “haze” as used herein refers to the scattering of light by a specimen responsible for the deduction of contrast of objects viewed through it. Percent of transmitted light that is scattered so that its direction deviates more than a specified angle from the direction of the incident beam. The specified angle in ASTM D 1003 is 0.044 radians or 2.5 degrees. Haze of less than about 5 percent is considered low when measured on a cast film of 0.8-1 mm in thickness. Two layers of good quality mineral glass of about 3 mm thick each (total 6 mm) can contribute about 0.25% haze. Therefore, the haze of an interlayer film and that of the resulting optical laminate formed from that film and good quality mineral glass of this thickness will differ by about 0.25%, provided there are substantially no surface effects such as patterns on the film surface that might increase haze but are not evident or present in the laminate. High optical quality film and laminates have a haze of less than about 2 percent, at the thickness used. Such an interlayer can be used in manufacturing of sound shields, screens, and the like. Applications such as special glass screens and some types of architectural glass have standards requiring a higher transparency of the final product, consistent with a haze no greater than about 1 percent. A haze no greater than about 1 percent is appropriate for large public building windows and other types of special architectural glass and glazing of cars and windows for trains and ships. A haze no greater than about 0.5 percent is appropriate for the front windshield of automobiles. Therefore, the haze value of a film used for an optical laminate is advantageously at most about 2, preferably at most about 1, more preferably at most about 0.5 percent, and most preferably at most about 0.25 percent. All of these values are for the thickness used in the application, but preferably also at a thickness of 0.125-1.0 mm (5-40 mil).

Haze is increased by interfacial effects such as the interface between a film and air. To overcome these effects and to see the actual haze inherent in the film, it is necessary to either laminate the film between two sheets of material such as glass that have the same refractive index as the film, or to immerse the film in a liquid with the same refractive index. When this technique is utilized, the haze for the sheet with its air interfaces is referred to as the “total haze” while the haze of the laminate or immersed film is described as the “internal haze.”

The term “adhesion to glass” as used herein refers to T-peel testing at 180°. This test measures the strength of the adhesion of the polymer film to glass. Unoriented films 154 mm×66 mm×2 mm are compression molded directly on plain untempered glass (203 mm×117 mm×4 mm) at 130° C. in a manual hot press such as the manual press commercially available from PHI-Tulip under the trade designation Model #PW-L425. Weighed amounts of pellets of the polymer being tested are placed between polytetrafluoroethylene (PTFE) sheets, heated at 130° C. at 35 psi (241 kPa) for 10 min, followed by 70 psi (482 kPa) for 10 min, and then removed from the heater plates allowed to air cool to ambient temperature, which requires about 5 min. The film thus made is kept between the two release sheets until it is ready to be tested. To test the film, one of the sheets of release material is removed so that the film can be adhered to a glass sheet. To create a tab that can be pulled in order to test the adhesion of the film to the glass, it is necessary to prevent adhesion of the film to the glass on one edge of the film. This is accomplished by placing a short piece (45 mm) of PTFE release sheet across one edge of the glass before laying the film with the remaining PTFE release sheet onto the glass. This assembly is again placed into the press to bond the film to the glass. After bonding, the top PTFE release sheet is removed. This gives a test specimen with a base layer of glass, a test sheet that is adhered to the glass for two thirds of its length but separated from the glass for the remaining third of its length by a thin release sheet. The film is pulled upward at 180 degrees from the glass sheet along the PTFE release film. When the tab of film is pulled, the configuration has a T shape with the glass as the cross bar and the film as the upright. This unbonded portion of the film (45 mm) is rolled very carefully to 180° and attached to an adhesive tape that is then gripped by the upper jaws of a peeling instrument commercially available from Sintech Corp. of Cary, N.C. under the trade designation MTS Sintech ReNew. Lower jaws of the instrument grip the glass surface at the bottom. The 2 mm thick film is peeled from the glass surface at a rate of 25 mm/min. The peeling is done at a very slow crosshead rate (25 mm/min or 1 inch/min) to minimize plastic stretching of the film at the interface. For the same reason, the film is 2 mm thick, a thickness sufficiently large to impart a high enough rigidity to avoid plastic stretching and allow only peeling at the interface when the sample is stretched. The load normalized by the width of the sample is reported as a function of the peel extension. Adhesion to glass is considered good when the steady state peel load is more than about 0.3 N/mm.

The term “peak load” as used herein is part of the procedure for measuring tear properties by ASTM D624. It refers to the maximum load or force, expressed in units of either Newtons or pounds, recorded during the constant strain rate testing of the sample. The peak load is the maximum force measured before a nick in the specimen propagates and reduces the stress. This test measures stress and strain at which the crack propagates and is believed to have use for screening materials for more expensive penetration resistance testing.

The term “total energy” as used herein refers to area under the stress-strain curve as measured by ASTM D624 utilizing Die B to prepare the test specimens. Generally, higher stiffness materials will result in higher peak loads. When comparing two materials with equivalent peak loads, the sample with the higher total energy is preferred because it demonstrates the presence of some mechanism such as strain hardening that allows the polymer to absorb greater energy.

The term “tear strength” as used herein refers to resistance to tearing as measured by ASTM D624 utilizing Die B to prepare the test specimens. This test measures the tendency of razor nicked sample to tear when in-plane tensile strain is applied. The maximum load achieved is divided by the thickness of the test specimen to obtain the tear strength which is usually reported in kN/m. This test is believed to be a predictor of penetration resistance by the ball drop test, but a precise correlation has not been made.

The term “penetration resistance” as used herein refers to resistance of a laminate to objects that hit it and might pass through it as measured by ANSI/SAE Z26.1-5.12 standard. In the case of glass laminates, each laminate is placed on a steel frame so that it is substantially horizontal at the time of impact. A 225 g solid steel spherical ball with diameter of 38 mm is dropped from a predetermined height once, freely and from rest, striking the specimen within 1″ (2.54 cm) of the center. Impact produces a large number of cracks in the glass. According to ANSI/SAE Z26.1-5.12.3, the fractured laminates are analyzed by the following criteria:

(1) Not more than two of the 12 specimens tested for each type and height shall break into separate large pieces.
(2) Furthermore, with no more than two of the remaining specimens shall the ball produce a hole or a fracture at any location in the specimen through which the ball will pass.
(3) At the point immediately opposite the point of impact, small fragments of glass may leave the specimen, but the small area thus affected shall expose less than 1 in² (6.45 cm²) of the reinforcing or the strengthening material, the surface of which shall always be covered with tiny particles of tightly adhering glass. Total separation of glass from the reinforcing or strengthening material shall not exceed 3 in² (19.35 cm²) on either side.
(4) Spalling of the outer glass surface opposite the point of impact and adjacent to the area of impact is not to be considered failure. Penetration resistance is considered high when the laminate passes the criteria for at least the 8 meter drop.

The term “security barrier” refers to a laminate which provides penetration protection at least to a height of 8 meters in the ANSI/SAE Z26.1-5.12 standard test. Such barriers protect, for instance, from thrown rocks, hail, and the like. Greater penetration protection may also be desirable, for instance in bullet resistant panels. To provide a security barrier, an inner layer is typically made from materials having a minimum elastic modulus of 25,000 psi (173 MPa), preferably a minimum modulus of 30,000 psi (207 MPa) as well as having a high penetration resistance.

The term “flexural modulus” measures the flexural stiffness of material in a three point bend as measured by ASTM D-790.

The term “UV-light transmittance” as used herein refers to the percentage of UV light that penetrates through a material. The UV-light transmittance is considered low when the UV-light transmittance is less than 5 percent.

The term “moisture absorption” as used herein refers to absorption of water as measured by ASTM D-570.

The term “moisture resistance” as used herein refers to the ability of a laminate to resist immersion in boiling water for an hour. Moisture resistance is considered high when the one hour immersion has no effect of the haze of the laminate, particularly on the exposed edges.

The term “modulus” as used herein refers to tensile modulus as measured by ASTM D412. This test measures the tensile properties of sheets. The tensile modulus generally ranges between 1.0 and 2.0 MPa for PVB but may be as high as 50 times higher for some commercial ionomer formulations. Flexural modulus by ASTM D790, tensile modulus by ASTM D638 measure different properties. ASTM D790 is not valid for testing thin films or very low modulus material.

Differential scanning calorimetry (DSC) is a common technique that can be used to examine the melting and crystallization of semi-crystalline polymers. General principles of DSC measurements and applications of DSC to studying semi-crystalline polymers are described in standard texts (for instance, E. A. Turi, ed., Thermal Characterization of Polymeric Materials, Academic Press, 1981).

The term “crystallinity” as used herein refers to means the regularity of the arrangement of atoms or molecules forming a crystal structure. Polymer crystallinity can be examined using DSC. Tₘₑ means the temperature at which the melting ends and Tₘₐₓ means the peak melting temperature, both as determined by one of ordinary skill in the art from DSC analysis using data from the final heating step. Differential Scanning Calorimetry (DSC) analysis is determined using a model Q1000 DSC from TA Instruments, Inc. Calibration of the DSC is done as follows. First, a baseline is obtained by running the DSC from −90° C. to 290° C. without any sample in the aluminum DSC pan. Then 7 milligrams of a fresh indium sample is analyzed by heating the sample to 180° C., cooling the sample to 140° C. at a cooling rate of 10° C./min followed by keeping the sample isothermally at 140° C. for 1 minute, followed by heating the sample from 140° C. to 180° C. at a heating rate of 10° C./min. The heat of fusion and the onset of melting of the indium sample are determined and checked to be within 0.5° C. from 156.6° C. for the onset of melting and within 0.5 J/g from 28.71 J/g for the heat of fusion. Then deionized water is analyzed by cooling a small drop of fresh sample in the DSC pan from 25° C. to −30° C. at a cooling rate of 10° C./min. The sample is kept isothermally at −30° C. for 2 minutes and heated to 30° C. at a heating rate of 10° C./min. The onset of melting is determined and checked to be within 0.5° C. from 0° C.

The propylene-based elastomers samples are pressed into a thin film at a temperature of 190° C. About 5 to 8 mg of sample is weighed out and placed in a DSC pan. A lid is crimped on the pan to ensure a closed atmosphere. The sample pan is placed in the DSC cell and the heated at a high rate of about 100° C./min to a temperature of about 30° C. above the melt temperature. The sample is kept at this temperature for about 3 minutes. Then the sample is cooled at a rate of 10° C./min to −40° C., and kept isothermally at that temperature for 3 minutes. Consequently the sample is heated at a rate of 10° C./min until complete melting. The resulting enthalpy curves are analyzed for peak melt temperature, onset and peak crystallization temperatures, heat of fusion and heat of crystallization, Tₘₑ, Tₘₐₓ, and any other quantity of interest from the corresponding thermograms as described in US Patent Application No (WO03040201). The factor that is used to convert heat of fusion into nominal weight % crystallinity is 165 J/g=100 weight % crystallinity. With this conversion factor, the total crystallinity of a propylene-based copolymer (units: weight % crystallinity) is calculated as the heat of fusion divided by 165 J/g and multiplied by 100%.

The term “tan delta” is a temperature and frequency dependent ratio of the loss modulus to the storage modulus (that is, G″/G′). In other words, the tan delta is the ratio of the portion of mechanical energy dissipated to the portion of mechanical energy stored (springiness) when a viscoelastic material undergoes cyclic deformation. Optimum damping of sound occurs at the maximum tan delta and more damping occurs when viscoelastic material is constrained in a sandwich than when it is extended or compressed. Preferred tie layers and interlayer materials for use in acoustic barriers or acoustically neutral laminates have a tan delta value of advantageously at least about 0.1 and preferably at most about 0.6 are generally found to help control the aesthetic quality of the transmitted sound (that is, sharpness value, loudness and Articulation Index).

The term “acoustic barrier” is used to describe a laminate that has sound deadening or frequency altering qualities at least equivalent to that of a 3.85 mm thick monolithic pane of glass.

The term “refractive index” or “index of refraction” is used herein to describe the change in direction (apparent bending) of light as it passes through the interface of a clear substance and a clear medium such as a vacuum or air. The refractive index is a constant for a given pair of materials. It can be defined as ratio of the speed of light in materials 1 and 2. This is usually written ₁n₂ and is the refractive index of material 2 relative to material 1. The incident light is in material 1 and the refracted light is in material 2. If the incident light is in a vacuum this value is called the absolute refractive index of material 2. In practice the refractive index in air is very little different because the refractive index of a vacuum is 1 while that of air is 1.0008. The index is the ratio of the sine of the angle of incidence to the sine of the angle of refraction or the ratio of the velocity of light in a vacuum to the velocity in the medium measured at the D line of sodium at 20° C. In a polymer, the index of refraction measured according to the procedures of ASTM D542-00.

“Density” refers to the mass per unit volume of a substance as determined by ASTM D-2839 or D-1505.

As used herein “stiff” refers to resistance to deformation resulting from the application of a steady force to a deformable medium. In this application, the terms “stiff” or “rigid” shall be used for any material which does not drape over an object, for instance the hand, if placed over it.

The term “optically transparent” or “transparent” or “optically clear” is used to describe an object that is capable of being seen through based upon unaided, visual inspection. This observation preferably corresponds to a minimum transmission of visible light, that is, a visible light transmission at least about 70%, preferably at least about 75%, and more preferably at least about 80%, most preferably at least about 90% at a haze value of at most about 10%, preferably at most about 5%.

The term “thermoplastic polymer” as used herein, refers to polymers, both crystalline and non-crystalline, which are melt processable under ordinary melt processing conditions and does not include polymers such as polytetrafluoroethylene which under extreme conditions, may be thermoplastic and melt processable.

“Mer unit” means that portion of a polymer derived from a single reactant molecule; for example, a mer unit from ethylene has the general formula —CH₂CH₂—.

The term “olefin polymer” or “polyolefin” means a thermoplastic polymer derived from one or more olefins. Representative olefins include ethylene, propylene, 1-butene, 1-hexene, 1-octene, 4-methyl-1-pentene, butadiene, cyclohexene, dicyclopentadiene, styrene, toluene, α-methylstyrene and the like. Aliphatic monounsaturated olefins are preferred and have the general formula Cₙ H₂ₙ, such as ethylene, propylene, and butene. The polyolefin can bear one or more substituents, for instance, a functional group such as a carbonyl, sulfide, and the like, but is preferably a hydrocarbon. In a polyolefin some mer units are derived from an olefinic monomer which can be linear, branched, cyclic, aliphatic, aromatic, substituted, or unsubstituted (for instance, olefin homopolymers, copolymers of two or more olefins, copolymers of an olefin and a non-olefinic comonomer such as a vinyl monomer, and the like). The term refers preferably to polymers and copolymers of ethylene or propylene or a combination thereof, including their copolymers with functionally substituted comonomers such as ethylene vinyl acetate copolymer and ionomer, most preferably to the hydrocarbon polymers and copolymers. Polyolefins can be linear, branched, cyclic, aliphatic, aromatic, substituted, or unsubstituted. Included in the term polyolefin are homopolymers of an olefin, copolymers of olefins, copolymers of an olefin and a non-olefinic comonomer copolymerizable with the olefin, such as vinyl monomers, modified polymers of the foregoing, and the like. Modified polyolefins include modified polymers prepared by copolymerizing the homopolymer of the olefin or copolymer thereof with an unsaturated carboxylic acid, for instance, maleic acid, fumaric acid or the like, or a derivative thereof such as the anhydride, ester metal salt or the like. They also include polyolefins obtained by incorporating into the olefin homopolymer or copolymer, an unsaturated carboxylic acid, for instance, maleic acid, fumaric acid or the like, or a derivative thereof such as the anhydride, ester metal salt or the like.

“Polypropylene” or “propylene polymer” means a polymer having at least half of its mer units derived from propylene. These include homopolymers of propylene as well as copolymers of propylene with one or more monomers copolymerizable therewith such as ethylene, butylene, pentene, hexene, heptene, octene, optionally including derivatives of such monomers and combinations thereof.

Random copolymer means a polymer having a random distribution of comonomer in a majority polymer, especially comonomer in propylene polymer, as contrasted with arrangements like block copolymers and impact copolymers. It is understood that complete statistical randomness may not occur and that there may be variation from one polymer molecule to the next within a polymer composition or polymer product.

The term low crystallinity propylene polymer is used herein to refer to propylene polymers having a crystallinity of less than about 47 percent, preferably at most about 34 percent, more preferably at most about 24 percent, most preferably at most about 18 percent. The crystallinity is preferably at least as low as that of historically commercially available propylene/ethylene polymers prepared with Ziegler Natta catalysts having at least about 6, more preferably at least about 11, most preferably at least about 15 weight percent ethylene. The term includes polymers having a heat of fusion of advantageously less than about 80, preferably less than about 60, more preferably less than about 40, most preferably less than about 30 Joules/g. Such crystallinity can be obtained using one or more comonomers polymerizable with propylene, especially α-olefins, preferably ethylene or in combinations including ethylene. Alternatively, such crystallinity can be obtained using lower molar concentrations of comonomer by controlling the insertion of ethylene or other α-olefin comonomers using catalysts different from Ziegler Natta catalysts. The term low crystallinity propylene polymer is used herein for one propylene polymer or a blend of propylene polymers.

The term “polyethylene” means a homopolymer of ethylene or an ethylene/alpha-olefin copolymer having a majority of its mer units derived from ethylene.

The term “ethylene/alpha-olefin copolymer” designates copolymers of ethylene with one or more comonomers selected from C₃ to C₂₀ alpha-olefins, such as 1-butene, 1-pentene, 1-hexene, 1-octene, methyl pentene and the like. Included are polymer molecules comprising long chains with relatively few side chain branches obtained by low pressure polymerization processes and the side branching that is present is short compared to non-linear polyethylenes (for instance, LDPE, a low density polyethylene homopolymer). Ethylene/alpha-olefin copolymers generally have a density in the range of from about 0.86 g/cc to about 0.94 g/cc. The term linear low density polyethylene (LLDPE) is generally understood to include that group of ethylene/alpha-olefin copolymers which fall into the density range of about 0.915 to about 0.94 g/cc or 0.930 when linear polyethylene in the density range from about 0.926 to about 0.95 is referred to as linear medium density polyethylene (LMDPE). Lower density ethylene/alpha-olefin copolymers may be referred to as very low density polyethylene (VLDPE), often used to refer to the ethylene/butene copolymers available from Union Carbide Corporation with a density ranging from about 0.88 to about 0.915 g/cc) and ultra-low density polyethylene (ULDPE), typically used to refer to certain ethylene/octene copolymers supplied by the Dow Chemical Company. Ethylene/alpha-olefin copolymers are the preferred polyolefins in the practice of the invention.

The phrase ethylene/alpha-olefin copolymer also includes homogeneous polymers such as metallocene-catalyzed EXACT™ linear homogeneous ethylene/alpha-olefin copolymer resins commercially available from the Exxon Chemical Company, of Baytown, Tex.; TAFMER™ linear homogeneous ethylene/alpha-olefin copolymer resins commercially available from the Mitsui Petrochemical Corporation; and long-chain branched, metallocene-catalyzed homogeneous ethylene/alpha-olefin copolymers commercially available from The Dow Chemical Company, for instance, known as AFFINITY™ or ENGAGE™ resins. The phrase “homogeneous polymer” refers to polymerization reaction products of relatively narrow molecular weight distribution and relatively narrow composition distribution. Homogeneous polymers are structurally different from heterogeneous polymers (for instance, ULDPE, VLDPE, LLDPE, and LMDPE) in that homogeneous polymers exhibit a relatively even sequencing of comonomers within a chain, a mirroring of sequence distribution in all chains, and a similarity of length of all chains, that is, a narrower molecular weight distribution. Furthermore, homogeneous polymers are most often prepared using metallocene, or other single-site type catalysts, rather than using Ziegler-Natta catalysts. Such single-site catalysts typically have only one type of catalytic site, which is believed to be the basis for the homogeneity of the polymers resulting from the polymerization.

LLDPE is an abbreviation for linear low density polyethylene and refers to copolymers of ethylene having: (1) a higher-alpha-olefin such as butene, octene, hexene, etc. as a comonomer; (2) a density of from about 0.915 to as high as about 0.930 grams per cubic centimeter; (3) molecules comprising long chains with few or no branches or cross-linked structures; and, (4) being produced at low to medium pressures by copolymerization using heterogeneous catalysts based on transition metal compounds of variable valance.

MDPE is an abbreviation for Medium density polyethylene and designates polyethylene having a density from about 0.930 to 0.950 g/cm³.

HDPE is an abbreviation for High density polyethylene and designates polyethylene having a density from about 0.950 to 0.965 g/cm³.

The term “substantially linear” means that, in addition to the short chain branches attributable to homogeneous comonomer incorporation, the ethylene polymer is further characterized as having long chain branches in that the polymer backbone is substituted with an average of 0.01 to 3 long chain branches/1000 carbons. Preferred substantially linear polymers for use in the invention are substituted with from 0.01 long chain branch/1000 carbons to 1 long chain branch/1000 carbons, and more preferably from 0.05 long chain branch/1000 carbons to 1 long chain branch/1000 carbons.

The substantially linear ethylene/α-olefin polymers are made by a continuous process using suitable constrained geometry catalysts, preferably constrained geometry catalysts as disclosed in U.S. Pat. Nos. 5,132,380, 5,703,187; and 6,013,819, the teachings of all of which are incorporated herein by reference. The monocyclopentadienyl transition metal olefin polymerization catalysts taught in U.S. Pat. No. 5,026,798, the teachings of which are incorporated herein by reference, and are also suitable for use in preparing the polymers of the present invention.

Long chain branching is defined herein as a branch having a chain length greater than that of any short chain branches which are a result of comonomer incorporation. The long chain branch can be as long as about the same length as the length of the polymer backbone. Long chain branching can be determined using methods within the skill in the art, for instance by using 13 C nuclear magnetic resonance (NMR) spectroscopy measurements, with quantification using, for instance, the method of Randall (Rev. Macromol. Chem. Phys., C29 (2&3), p. 275-287).

For the substantially linear ethylene/α-olefin polymers used in the compositions of the invention, the I₁₀/I₂ ratio indicates the degree of long chain branching, that is, the higher the I₁₀/I₂ ratio, the more long chain branching in the polymer. Generally, the I₁₀/I₂ ratio of the substantially linear ethylene/α-olefin polymers is at least about 5.63, preferably at least about 7, especially at least about 8 or above, and as high as about 25. The melt index of a substantially linear ethylene polymer is measured according to ASTM D-1238 condition 190° C./2.16 Kg (formerly known as Condition E).

As used herein, the term polybutene refers to those polymeric entities comprised of butene and, optionally, another monomeric unit such as ethylene, propylene, 1-hexene, 4-methyl-1-pentene, 1-octene, and 1-decene units, with the butene monomeric unit comprising the major component of the copolymer. This polymer is sometimes referred to as polybutylene. Polybutene is frequently produced by polymerizing a C4 hydrocarbon fraction obtained from the cracking of naphtha etc. and containing isobutylene, 1,2-butene, 2,3-butene, etc. in the presence of a catalyst such as boron trifluoride or aluminum chloride. It may also be prepared using Ziegler Natta catalysis. A preferred polybutene polymer is a mixture of polybutenes and polyisobutylene prepared from a C4 olefin refinery stream containing about 6 weight percent to 50 weight percent isobutylene with the balance a mixture of butene (cis- and trans-) isobutylene and less than 1 wt % butadiene. Particularly, preferred is a polymer prepared from a C4 stream composed of 6-45 wt. % isobutylene, 25-35 wt. % saturated butenes and 15-50 weight percent 1- and 2-butenes. Such polymers are often prepared by Lewis acid catalysis such as using an aluminum chloride based catalyst or a boron fluoride based catalyst. Such polybutenes range from light mobile liquids to extremely viscous gels. Basically the longer the polymer chain is allowed to grow, the higher the viscosity. Polybutenes have many of the characteristics of iso-paraffinic hydrocarbons and non-branched paraffin oils but are classified as a true polymer rather than a hydrocarbon liquid.

The term “tackifier” as used herein refers to a substance that is added to synthetic resins or elastomeric adhesives to improve the initial and extended tackiness of the film. Tackifiers are exemplified by a number of different types and classes of natural and synthetics resins. These include resin esters, rosin and rosin derivatives, hydrogenated rosin, polymerized terpenes, coumarone-indene resins, petroleum hydrocarbon resins, hydrogenated hydrocarbon resins. Tackifiers are typically low molecular weight amorphous glassy solids at room temperature. Hydrogenated tackifiers are preferentially used with polyolefins.

As used herein, the term “graft copolymer” means a copolymer produced by the combination of two or more chains of constitutionally or configurationally different features, one of which serves as a backbone main chain, and at least one of which is bonded at some point(s) along the backbone and constitutes a side chain. Thus, graft copolymers can be described as polymers having pendant polymeric side chains, and as being formed from the “grafting” or incorporation of polymeric side chains onto or into a polymer. The polymer to which the grafts are incorporated can be homopolymers or copolymers. The graft copolymers are derived from a variety of monomer units.

The term “grafted” means a copolymer has been created which comprises side chains or species bonded at some point(s) along the backbone of a parent polymer.

As used herein, the term “grafting” means the forming of a polymer by the bonding of side chains or species at some point(s) along the backbone of a parent polymer. Such processes are well within the skill in the art such as disclosed by Sperling, L. H., Introduction to Physical Polymer Science 1986 pp. 44-47.

The term “graft copolymerization” is used herein, unless otherwise indicated, to mean a copolymer which results from the formation of an active site or sites at one or more points on the main chain of a polymer molecule other than its end and exposure to at least one other monomer.

A clarifier is a type of nucleating agent that improves clarity of a film or other polymeric substance.

A nucleating agent is a compound or composition added to a polymer to assist in reduction of the dimension of crystalline structures in the polymer. Nucleating agents are observed to provide stability, particularly of optical properties, after exposure to conditions that might otherwise result in formation of more or larger crystalline structures in a polymer, such as heating or reheating during any stage including formation, lamination, and weathering. Nucleating agents, also called nucleators, are exemplified by compounds derived from adipic acid and very small particles of minerals such as submicronized powders of calcium sulfate or calcium carbonate, preferably those nucleating agents commercially available from Milliken Corp. under the trade designation MILLAD including MILLAD 3905 nucleating agent ((1,3:2,4) Dibenzylidene sorbitol), MILLAD 3940 nucleating agent ((1,3:2,4) Diparamethyldibenzylidene sorbitol) and MILLAD 3988 clarifying agent (3,4-dimethylbenzylidene sorbitol). The nucleating agent is believed to improve haze by increasing the number of nucleation sites at which crystallization occurs, effectively decreasing crystallite size and leading to reduced haze [maintaining crystallinity at a lower level than would obtain without the agent]. Some substances having particle sizes sufficient to increase haze in a polymer, for instance talc, may be effective nucleating agents but ineffective as clarifiers.

As used herein, the term “clarity enhancer” refers to any material that improves clarity, either initially or after processing or aging. While clarifiers as previously defined are included in the use of the term, preferred clarity enhancers are such materials as crosslinking agents which, when reacted with at least one polymer in an interlayer film composition result in films having greater clarity, reduced haze or both, or other polymers which when admixed with the polymers in an interlayer film composition result in a film having higher clarity, less haze or a combination thereof, than is obtained in an interlayer film of the same composition except without the clarity enhancer or enhancers. The clarity enhancers that differ from clarifiers defined previously are referred to herein as “integral clarity enhancers” because they are associated with the structure of the polymer, in the case of crosslinking, or with the identity of the resulting polymer blend, in the case of additional polymers. In some instances the effect of a clarity enhancer is not evident immediately on formation of a film; rather the effect is evident after time and handling, often thermal processing, when the clarity enhancer helps reduce development or accumulation of haze, for instance from crystal formation or recrystallization into larger crystals.

As used herein, the term “adhesion enhancer” refers to any material that improves the adhesion of a film of the invention to the substrate to which it is laminated or adhered over the adhesion that would be obtained by a film of the same composition when the adhesion enhancer is not used. An adhesion enhancer is optionally used substantially exterior to the film (referred to herein as “exterior adhesion enhancer”), for instance as a tie layer or primer, or substantially internal to the film (referred to herein as “internal adhesion enhancer”) for instance a coupling agent, polymer or polymer composition that improves adhesion or grafted monomer. It is recognized by those skilled in the art that some tie layers or primers may permeate into a film and that some materials useful as interior adhesion enhancers may bleed out of a polymer composition or film to varying degrees, therefore, the term “substantially” is understood in descriptions of the primary location of the adhesion enhancer as interior or exterior.

A “coupling agent” as used herein is a compound or composition which, when admixed with the other components of the interlayer composition of the invention, improves the adhesion or bonding of the interlayer to mineral glass, polymer glass or any other material to which adhesion is desired (hereinafter substrate). Thus, a coupling agent is one type of adhesion enhancer. Coupling agents can alternatively or additionally be applied to a substrate, often referred to as a primer for the substrate. This, too, enhances adhesion to the substrate. Preferably, primer coating of the substrate is not needed when sufficient coupling agent is used. Coupling agents are exemplified by silanes, siloxanes, titanates, and combinations thereof, preferably vinyl alkoxy silanes and amine alkoxy silanes, more preferably vinyl-triethoxy-silane, amino-propyl-triethoxysilane, and combinations thereof. Preferred coupling agents have dual functionality which allows chemical links to form between the coupling agent and the polymer and between the coupling agent and the substrate. The vinyl alkoxy silane family of meets this criteria. The vinyl functionality may be grafted to an olefin polymer by means of peroxide grafting. This creates siloxane functional polymer that can be crosslinked in the presence of moisture and temperature or will bond to the hydroxyl groups of glass. Such dual functionality coupling agents are within the skill in the art. Amine functional alkoxy silanes have been widely used to couple epoxy formulations to glass and other polar substrates. In these applications, the alkoxy silane provides a reactive site for bonding to the glass while the amine functionality can react with epoxy functionality.

A “crosslinking agent” as used herein is a compound or composition which, when admixed with the other components of the interlayer composition of the invention results in crosslinking between polymer chains, usually and preferably when another condition is provided such as sufficient heat or sufficient radiation, for instance, UV light, electron beam or other energy source.

A UV light absorber is a compound or composition which is added to block UV-light that would otherwise penetrate the interlayer and to protect from the negative effects of the UV light.

The term “filler” as used herein includes particulates and/or other forms of materials which can be added to a film polymer extrusion material which will not chemically interfere with or adversely affect the extruded film and further which are capable of being uniformly dispersed throughout the film. Generally the fillers will be in particulate form with average particle sizes in the range of about 0.1 to about 10 microns, desirably from about 0.1 to about 4 microns; however, nanoparticle fillers are also suitable for use in the practice of the invention, for instance to scatter visible light or block UV light.

The term “plasticizer” is generally used to designate a relatively nonvolatile liquid which is admixed with a polymer to render it more flexible and workable believed to function by intrusion between polymer chains. Plasticizers are exemplified by (liquid) phthalate diesters. According to the teachings of Beckmann in U.S. Pat. No. 4,303,739, the term can also be applied to “internal plasticizers” which are vinyl acetate monomers interpolymerized into a polymer to achieve desirable flexibility.

As used herein, the term “particle size” describes the largest dimension or length of the filler particle.

“Film” refers to a sheet, non-woven or woven web or the like or combinations thereof, having length and breadth dimensions and having two major surfaces with a thickness therebetween. A film can be a monolayer film (having only one layer) or a multilayer film (having two or more layers). A multilayer film is composed of more than one layer preferably composed of at least two different compositions, advantageously extending substantially the length and breadth dimensions of the film. Layers of a multilayer film are usually bonded together by one or more of the following methods: coextrusion, extrusion coating, vapor deposition coating, solvent coating, emulsion coating, or suspension coating. A film, in most instances, has a thickness of up to about 20 mils (5×10⁻⁴ m); although common use of the term sometimes refers to material as film when a thickness is less than 10 mils (2.5×10⁻⁴ m) and as a sheet when the thickness is greater.

The term “sheet” as used herein means a material having two substantially parallel planar surfaces of much larger dimensions than its third dimension, or thickness, but somewhat thicker or stiffer than a film, for instance a material having a thickness greater than about 10 mils (2.5×10⁻⁴ m) up to about 100 mm or greater.

“Layer” means herein a member or component forming all or a fraction of the thickness of a structure wherein the component is preferably substantially coextensive with the structure and has a substantially uniform composition.

The term “monolayer film” as used herein means a film having substantially one layer. Optionally, however, more than one ply of monolayer film is used in an application with or without one or more adhesives between adjacent plies. Thus, a film is considered monolayer if it is formed in a process considered in the art to be a monolayer process, for instance, formed by a double bubble process rather than a coextrusion process, even if two layers of a composition according to the practice of the invention are used adjacent to one another or even with an adhesive between the layers.

The term “multilayer film” means a film having two or more layers. A multilayer film is composed of more than one layer preferably composed of at least two different compositions, advantageously extending substantially the length and breadth dimensions of the film. Layers of a multilayer film are usually bonded together by one or more of the following methods: coextrusion, extrusion coating, vapor deposition coating, solvent coating, emulsion coating, or suspension coating. A film, in most instances, has a thickness of up to about 30-35 mils (7.5-8×10⁻⁴ m).

The term “tie layer” or “adhesive layer” or “bonding layer” means an inner layer having a primary purpose of providing interlayer adhesion to directly adjacent or contiguous layers, for instance between the interlayer and a glass. The tie layer may also impart other characteristics to the multicomponent structure of which it is a part.

As used herein “contiguous” or “directly adjacent,” when referred to two layers, is intended to refer to two layers that are directly adhered one to the other. In contrast, as used herein, the word “between”, as applied to a film layer expressed as being between two other specified layers, includes both direct adherence of the subject layer to the two other layers it is between, as well as lack of direct adherence to either or both of the two other layers the subject layer is between, that is, one or more additional layers can be imposed between the subject layer and one or more of the layers the subject layer is between.

“Laminate” refers to a material made up of two or more layers of material bonded or adhered together, and includes a multilayer film, such as a coextruded film. A rigid laminate is a laminate having sufficient thickness or at least one sufficiently rigid layer to prevent draping and sustain its shape upon handling.

The term “glass” as used herein refers to mineral glass sheets as well as transparent optically clear rigid polymer sheets, such as sheets of a polycarbonate or acrylic plastic, referred to herein as polymer glass. Typically glass is useful for forming the outer surface or surfaces of a transparent, impact resistant, preferably acoustical barrier glazing. Mineral glass, that is, soda-lime-silicate glass, polycarbonate, polymethylmethacrylate, polyacrylate and cyclic polyolefins (for instance, ethylene norbornene and metallocene-catalyzed polystyrene), and combinations thereof, are useful in the outer faces of such glazings.

The term “rigid” as used herein refers to an object which is self-sustaining in shape. While it may be somewhat flexible, it does not drape.

The term “safety glass” is used to designate a laminate of two glass sheets bonded together using at least one interlayer of a polymer film placed between the two glass sheets. One or both glass sheets are optionally optically clear rigid polymer sheets.

“Extrusion,” and “extrude,” refer to the process of forming continuous shapes by forcing a molten plastic material through a die, followed by cooling or chemical hardening. Immediately prior to extrusion through the die, the relatively high-viscosity polymeric material is fed into a rotating screw, which forces it through the die.

“Coextrusion,” and “coextrude,” refer to the process of extruding two or more materials through a single die with two or more orifices arranged so that the extrudates merge and weld together into a laminar structure before cooling or chilling, that is, quenching. Coextrusion is often employed as an aspect of other processes, for instance, in film blowing, casting film, and extrusion coating processes.

“Blown film” or “film blowing” refers to a process for making a film in which a thermoplastic polymer or co-polymer is extruded to form a bubble filled with heated air or another hot gas in order to stretch the polymer. Then, the bubble is collapsed and collected in flat film form.

“Skin layer” means an outer layer including an outside layer, thus any layer which is on an exterior surface of a film or other multicomponent structure. A surface layer advantageously provides wear resistance, protection of inner layers which may be more susceptible to deterioration, a desired degree of adhesion or resistance to adhesion to a material or object it is adapted to contact, or similar characteristics, generally different from those of inner layers.

“Molecular weight” is the weight average molecular weight. Molecular weight and molecular weight distributions of the propylene based polymers are determined using gel permeation chromatography (GPC) on a Polymer Laboratories PL-GPC-220 high temperature chromatographic unit equipped with four linear mixed bed columns (Polymer Laboratories (20-micron particle size)). The oven temperature is at 160° C. with the autosampler hot zone at 160° C. and the warm zone at 145° C. The solvent is 1,2,4-trichlorobenzene containing 200 ppm 2,6-di-t-butyl-4-methylphenol. The flow rate is 1.0 milliliter/minute and the injection size is 100 microliters. About 0.2% by weight solutions of the samples are prepared for injection by dissolving the sample in nitrogen purged 1,2,4-trichlorobenzene containing 200 ppm 2,6-di-t-butyl-4-methylphenol for 2.5 hrs at 160° C. with gentle mixing.

Number average molecular weight (Mn) is a measure of average chain length based on monomer repeat unit units per chain and is calculated from the molecular weight distribution curve measured by gel permeation chromatography.

Weight average molecular weight (Mw) is a measure of average chain length based on a weighted average and is calculated from the molecular weight distribution curve measured by gel permeation chromatography.

Molecular weight distribution (MWD) or polydispersity is Mw/Mn and is a measure of the similarity of molecular weights in a sample of polymer. Polymers made using metallocene catalysts commonly have MWD less than about 5, advantageously less than about 4, more advantageously less than about 3.5, preferably less than about 3, more preferably less than about 2.5, most preferably less than about 2.

The terms “melt flow rate” and “melt index” are used herein to mean the amount, in grams, of a thermoplastic resin which is forced through an orifice of specified length and diameter in ten minutes under prescribed conditions in accordance with ASTM D 1238. In the case of propylene polymers the conditions for I₂ are 230° C./2.16 Kg (formerly known as Condition E). In the case of ethylene polymers the conditions are 190° C./2.16 Kg (formerly known as Condition E).

The term “crystallization” as used herein means the rearrangement of a portion of polymer molecules into more organized, denser structures commonly called crystallites, as measured by the described crystallization temperature test. Polymer crystallization normally occurs during the cooling of monolayer films prepared by extrusion or other melt processes.

The term “toughness” as used herein refers to the energy required to break a sample of film during a standard tensile test as measured by the procedures of ASTM D-882.

The term “tear resistance” as used herein refers to the force needed to propagate the tear of a notched film sample also known as Elmendorf tear as measured by the procedures of ASTM D-1922.

The term “dart drop impact strength” as used herein refers to the resistance to breaking by a dropped dart and is measured by the procedures of ASTM D-1709.

“Glass transition temperature” is the temperature at which the glass transition inflection point occurs in a DSC (Differential Scanning Calorimeter). It is measured on a sample that is first melted at 185° C. and then rapidly cooled to ambient temperature by removing from the oven and placing on the bench top or metal surface. The sample is then immediately placed in the DSC, cooled to −30° C., equilibrated at −30° C. for 60 seconds and scanned from −30° C. to 100° C. at 10° C./minute. The glass transition temperature is then measured as the temperature of the inflection point between the onset and endpoint of the glass transition.

The term “softening temperature” is the temperature at which a polymer is observed to soften sufficiently to allow the penetration of a weighted probe that is placed in contact with the polymer surface. It is measured by thermomechanical analysis (TMA).

“Rheological properties” refer to properties that affect the deformation and flow of a material. Melt viscosity, melt strength and draw ratio are examples of rheological properties.

The term “surface texture” refers to patterns that are induced to form on the surface of the polymer film. These can be induced to form by several methods, including melt fracture at the polymer surface during extrusion or by embossing the heated film as it emerges from the die with a patterning substrate.

For purposes of this invention, a polymer or polymer composition is considered to exhibit “elastic” behavior (i.e. is an “elastomer”) if the polymer or polymer composition conforms to the following description. ASTM D1708 microtensile samples are cut from a compression molded plaque (see subsequent description). Using an Instron Model 5564 (Instron Corporation, Norwood, Mass.) fitted with pneumatic grips and a 100 N load cell, the sample is deformed to 100% strain at 500%/min from an initial gauge length of 22.25 mm at 23°+2° C. and 50+5% relative humidity. The grips are returned to the original position and then immediately extended until the onset of a positive tensile stress (0.05 MPa) is measured. The strain corresponding to this point is defined to be the permanent set. Samples which exhibit a permanent set of less than or equal to 40% strain are defined as elastic.

The following is an exemplary calculation for an arbitrary propylene/ethylene polymer:

### Initial Length (Lₒ): 22.25 mm

Length at 100% strain during 1^{st} cycle, extension: 44.5 mm
Length at Tensile Stress during 2^{nd} cycle at 0.05 MPa (L′): 24.92 mm

$$Permanent Set = \frac{{L}^{′} - {L}_{0}}{{L}_{0}} \times 100 \% \\ = \frac{24.92 mm - 22.25 mm}{22.25 mm} \times 100 \% \\ = 12 \%$$

Since a permanent set of 12% is less than 40% strain, this material qualifies as “elastic” (that is, it is an “elastomer”).

The term “domain(s)” is understood to mean a discrete, that is, a separate and distinct, area or region.

By “dispersive mixing” it is meant that the materials being mixed are broken down into very small particles, droplets or “domains” which readily become dispersed among themselves and which can later be distributed, substantially homogeneously, among other ingredients. This dispersive mixing stage can be thought of as a disentanglement and “breaking down” stage for components which are most difficult to disperse. Dispersive mixing is often used for mixing non-uniform constituents such as powders into liquids in which case agglomerates of powder must be disintegrated so that each particle can be surrounded by liquid, and pellets of thermoplastic which have not yet melted and are desired to be melted and mixed into the molten phase. Dispersive mixing often involves minimal mechanical energy, for instance, an effective shear rate of at least about 200 sec-1. Such well known devices as a media mill, attritor, hammer mill, Microfluidizer™ (commercially available from Microfluidics Corp), homogenizer, jet mill, fluid mill and similar high energy dispersing devices can be used to achieve dispersive mixing.

The term “distributive mixing” is used hereto indicate a mixing operation which promotes optimum spatial rearrangement of components so as to minimize non-uniformity of the composition. By way of analogy, the “dispersive mixing” stage, causes materials to be “broken down” into very small particles, droplets or domains while a “distributive mixing” stage, which often occurs further downstream in a continuous process, causes these very small particles, droplets or domains to become evenly distributed among the remaining components. Distributive mixing often refers to mixing of lower intensity than that of dispersive mixing, that is mixing of a stirring character.

The term “dispersive shear” as used herein means shear energy applied to molten polymer domains by use of kneading elements in a twin screw extruder that smear the polymer between rotating kneading elements and the barrel of the twin screw extruder. The result of such dispersive shear is to reduce the size of the molten polymer domains. Said dispersive shear does little if anything to distribute the molten polymer domains evenly within the given volume.

The term “conveying elements” is used to describe extruder elements having flights of various pitch angles. Whether or not an element of the conveying type is, in fact, conveying, depends upon the pitch angle which may be “positive” or “negative” in relation to the axis of rotation. In this context, the expressions “positive pitch angle” and “negative pitch angle” will be used herein as synonymous with “positive pitch” and “negative pitch”, respectively. Generally, a positive pitch will cause flow of material towards the outlet (“downstream direction”) while a negative pitch will cause flow of material towards the inlet (“upstream direction”).

The term “distributive mixing elements” is used to describe elements in an extruder screw assembly that accomplish distributive mixing. Frequently these elements are gear shaped discs perpendicular to the axis of the machine that divide the material into separate strands that are cut in the intermeshing region of a twin screw. Alternatively, the discs may have a positive or negative pitch to accomplish greater mixing and to ensure that there are no dead areas of the barrel that are not wiped by the flights of the element. Such elements are commercially available from Coperion under the trade designation ZME elements. Alternatively, the shortest length negative pitched kneading blocks, those with total length approximately equivalent to half a diameter of the extruder, have insufficient surface area in running along the barrel of the extruder to create dispersive shear but do serve as distributive mixers.

The term “kneading elements” is used herein to refer to elements in a extruder screw assembly that force polymer through the gap between their lobes and the barrel of an extruder. These elements are often generally oval shaped metal disks. The narrow portion of the oval allows volume for polymer. The rotation of the element creates drag which pulls the polymer into the space between the disk and the barrel of the extruder. The conventional thickness of the disk is one fifth the diameter of the extruder. The kneading elements are usually assembled into blocks consisting of more than one individual element, with the length, or number of blocks controlling the amount of dispersive and distributive mixing. The individual elements can then be staggered such that the second element is oriented at an angle to the first element. If the angle of the stagger is similar the angle of the screw elements it is called a forwarding kneading block and will convey material from the feed toward the exit of the extruder. If the angle of stagger is contrary to that of the screw elements it is referred to as a reverse kneading block. Lastly, if the kneading elements are oriented at right angles, 90°, to each other, the block is referred to as a neutral kneading block. The longer the kneading block, the more the material in free volume of the disk is forced between the disc and the barrel rather than cascading over the disk and onto the next disk in the direction of flow.

The terms “admixing”, “mixing” and “mixtures” are used synonymously herein with such terms as “interblending”, “blending”, and “blend” and are intended to refer to any process that reduces non-uniformity of a composition that is formed of two or more constituents. This is an important step in polymer processing because mechanical, physical and chemical properties as well as product appearance generally are dependent upon the uniformity of the composition of a product. Accordingly, “mixture” or “admixture” as result of a mixing step is defined herein as the state formed by a composition of two or more ingredients which may but need not bear a fixed proportion to one another and which, however commingled, may but need not be conceived as retaining a separate existence. Generally, a mixing step according to the invention is an operation which is intended to reduce non-uniformity of a mixture.

All percentages, preferred amounts or measurements, ranges and endpoints thereof herein are inclusive, that is, “less than about 10” includes about 10. “At least” is, thus, equivalent to “greater than or equal to,” and “at most' is, thus, equivalent “to less than or equal to.” Numbers herein have no more precision than stated. Thus, “105” includes at least from 104.5 to 105.49. Furthermore, all lists are inclusive of combinations of any two or more members of the list. All ranges from a parameters described as “at least,” “greater than,” “greater than or equal to” or similarly, to a parameter described as “at most,” “up to,” “less than,” “less than or equal to” or similarly are preferred ranges regardless of the relative degree of preference indicated for each parameter. For instance, a range that has an advantageous lower limit combined with a most preferred upper limit is preferred for the practice of this invention. All amounts, ratios, proportions and other measurements are by weight unless stated otherwise. All percentages refer to weight percent based on total composition according to the practice of the invention unless stated otherwise. Unless stated otherwise or recognized by those skilled in the art as otherwise impossible, steps of processes described herein are optionally carried out in sequences different from the sequence in which the steps are discussed herein. Furthermore, steps optionally occur separately, simultaneously or with overlap in timing. For instance, such steps as heating and admixing are often separate, simultaneous, or partially overlapping in time in the art. Unless stated otherwise, when an element, material, or step capable of causing undesirable effects is present in amounts or in a form such that it does not cause the effect to an unacceptable degree it is considered substantially absent for the practice of this invention. Furthermore, the terms “unacceptable” and “unacceptably” are used to refer to deviation from that which can be commercially useful, otherwise useful in a given situation, or outside predetermined limits, which limits vary with specific situations and applications and may be set by predetermination, such as performance specifications. Those skilled in the art recognize that acceptable limits vary with equipment, conditions, applications, and other variables but can be determined without undue experimentation in each situation where they are applicable. In some instances, variation or deviation in one parameter may be acceptable to achieve another desirable end.

The term “comprising”, is synonymous with “including,” “containing,” or “characterized by,” is inclusive or open-ended and does not exclude additional, unrecited elements, material, or steps. The term “consisting essentially of” indicates that in addition to specified elements, materials, or steps; elements, unrecited materials or steps may be present in amounts that do not unacceptably materially affect at least one basic and novel characteristic of the subject matter. The term “consisting of” indicates that only stated elements, materials or steps are present.

This invention comprises a film useful as an interlayer, a composition useful to make the film, and a laminate comprising the film and at least one rigid or optically transparent substrate or combination thereof. The composition is obtainable from (a) at least one low crystallinity propylene polymer, and at least one (b) internal adhesion enhancer, (c) at least one clarity enhancer or (d), more preferably, both (b) and (c). The clarity enhancer is preferably a integral clarity enhancer. The film comprises such a composition or at least one low crystallinity propylene polymer, and at least one adhesion enhancer, which may be internal or external. In each instance, the composition, whether as a composition or in film form, consists essentially of the stated components, or stated another way, preferably the components listed account for at least about 85, more preferably at least about 90, most preferably at least about 95 weight percent of the composition, with the remainder preferably being additives within the skill in the art, for instance to improve stability, acoustic qualities, processing properties, or further improve clarity or haze or achieve desired adhesion or to reduce the amount of UV light that is allowed to penetrate and damage on the other side of a laminate comprising such a film.

The first component is the low crystallinity propylene polymer, which is a polymer having at least 50, advantageously at least about 51, preferably at least about 60, more preferably at least about 70, most preferably at least about 80 percent mer units derived from propylene based on total weight of the polymer. The remainder of the mer units are derived from at least one monomer interpolymerizable with propylene, preferably at least one α-olefin, preferably ethylene or butene, more preferably ethylene. When ethylene is copolymerized with propylene, the low crystallinity propylene polymer has an ethylene content of advantageously at least about 8, preferably at least about 9, more preferably at least about 10, most preferably at least about 11, and advantageously at most about 30, preferably at most about 25, more preferably at most about 20, most preferably at most about 15 percent of ethylene based on the total weight of the low crystallinity propylene polymer. A polypropylene with too little comonomer may be so crystalline that it has undesirable haze and limited puncture and tear resistance. While it would be desirable to achieve a degree of crystallinity below that of polypropylenes having 30 weight percent ethylene, in currently available polymers, the higher amounts of ethylene are associated with a stickiness or blockiness that renders films difficult to manufacture, handle and process for lamination. Furthermore, amounts of ethylene in excess of about 15 percent may increase haze to be dealt with using other means described herein when it is desirable to limit haze. The low crystallinity propylene polymer advantageously has a melt flow ratio (MFR) measured by the procedures of ASTM D 1238 under conditions of 2.16 kilograms and 230° C. of preferably at least about 0.5, more preferably at least about 1.0, most preferably at least about 1.5, and preferably at most about 20, more preferably at most about 10, most preferably at most about 5.0.

The low crystallinity propylene polymer preferably has a narrow molecular weight distribution of less than about 4.0, more preferably less than about 3.5, most preferably less than about 3. In one embodiment, low crystallinity propylene polymers of these molecular weight distributions are available through use of single site, including but not preferably metallocene, catalysts, for instance those disclosed in U.S. Pat. No. 6,500,653 or US2004005984 (WO2003/091262) which show the skill in the art and are incorporated by reference herein to the fullest extent permitted by law. Preferably the catalyst is as disclosed in US2004005984, preferably where the heteroatoms are oxygen, preferably where the ligand includes a biphenylphenol structure or derivative thereof, more preferably having hafnium as a metal, and most preferably is used with a borate activator.

In one preferred embodiment, the low crystallinity propylene polymer preferably has a narrow crystallinity distribution. The crystallinity distribution is determined as described in U.S. Pat. No. 6,500,563, where it is referred to as a substantially uniform compositional distribution. The distribution is determined by thermal fractionation in a solvent, preferably a hydrocarbon such as hexane. About 30 g of sample is cut into about 0.3 cm cubes, mixed with 50 g of Irganox™ 1076 antioxidant commercially available from Ciba-Geigy Corp. then 425 mil of hexane and maintained for two 24 hour periods at each of 23° C., 31° C., 40° C., 48° C., 55° C., 62° C. and at as many successive intervals of about 8° C. as it takes for the sample to be dissolved, optionally using a different solvent. Solvent is replaced after each 24 hour period. The solutions for each temperature are combined and evaporated to leave a residue which is weighed and analyzed by infrared spectroscopy to determine weight percent ethylene. Preferably, at least about 75, more preferably at least about 85 weight percent of the polymer is isolated in one or two adjacent soluble fractions and each of these fractions has a weight percent ethylene content preferably within at most about 20, more preferably at most about 10 weight percent of the average weight percent of ethylene in the low crystallinity propylene polymer.

In another particularly preferred embodiment of the invention, the low crystallinity propylene polymer utilized in the invention comprises a propylene-ethylene copolymer made using a nonmetallocene, metal-centered, heteroaryl ligand catalyst as described in U.S. patent application Ser. No. 10/139,786 filed May 5, 2002 (published as PCT application WO 03/040201), which demonstrates the skill in the art and is incorporated by reference herein in its entirety to the fullest extent permitted under law, especially for its teachings regarding such catalysts and for properties of polymers produced using such catalysts. For such catalysts, the term “heteroaryl” includes substituted heteroaryl. Propylene-based elastomers made with such nonmetallocene, metal-centered, heteroaryl ligand catalyst exhibit a unique regio-error. The regio-error is identified by 13C NMR peaks corresponding at about 14.6 and about 15.7 ppm, which are believed to be the result of stereo-selective 2,1-insertion errors of propylene units into the growing polymer chain. In this particularly preferred aspect, these peaks are of about equal intensity, and they typically represent about 0.02 to about 7 mole percent of the propylene insertions into the copolymer chain. These low crystallinity propylene polymers are hereinafter referred to as heteroaryl-catalyzed propylene polymers.

The heteroaryl-catalyzed propylene polymer preferably has a molecular weight distribution (Mw/Mn) of less than 3.5, preferably less than 3.0.

The weight-averaged molecular weight (Mw) of the heteroaryl-catalyzed propylene polymer is advantageously at least about 30,000, more advantageously at least about 54,000, most advantageously at least about 90,000 preferably at least about 110,000, more preferably at least about 150,000, most preferably at least about 165000 and advantageously at most about 1,000,000, preferably at most about 750,000, more preferably at most about 500,000.

The heteroaryl-catalyzed propylene polymer preferably and exhibits a heat of fusion (ΔH) by Differential Scanning Calorimetry of at least about 1 Joule per gram, preferably at least about 2; advantageously at most about 35, more advantageously at most about 25, preferably at most about 15, more preferably at most about 12, and most preferably at most about 6 Joules/gram.

In a particularly preferred aspect of the invention, the heteroaryl-catalyzed propylene polymer is a propylene-based elastomer (preferably propylene-ethylene elastomer) characterized by a DSC curve with a Tₘₑ that remains essentially the same and a Tₘₐₓ that decreases as the amount of unsaturated comonomer in the copolymer is increased.

In a particularly preferred aspect of the invention, the heteroaryl-catalyzed propylene polymer is a propylene-based elastomer exhibiting broad crystallinity distribution. For elastomers having a heat of fusion greater than about 20 Joules/gram, the crystallinity distribution preferably is determined from TREF/ATREF analysis as described below.

The determination of crystallizable sequence length distribution can be accomplished on a preparative scale by temperature-rising elution fractionation (TREF). The relative mass of individual fractions can be used as a basis for estimating a more continuous distribution. L. Wild, et al., Journal of Polymer Science: Polymer. Physics Ed., 20, 441 (1982), scaled down the sample size and added a mass detector to produce a continuous representation of the distribution as a function of elution temperature. This scaled down version, analytical temperature-rising elution fractionation (ATREF), is not concerned with the actual isolation of fractions, but with more accurately determining the weight distribution of fractions.

While TREF was originally applied to copolymers of ethylene and higher α-olefins, it can also be used for the analysis of isotactic copolymers of propylene with ethylene (or higher α-olefins). The analysis of copolymers of propylene requires higher temperatures for the dissolution and crystallization of pure, isotactic polypropylene, but most of the copolymerization products of interest elute at similar temperatures as observed for copolymers of ethylene. The following table is a summary of conditions used for the analysis of copolymers of propylene. Except as noted the conditions for TREF are consistent with those of Wild, et al., ibid, and Hazlitt, Journal of Applied Polymer Science: Appl. Polym. Symp., 45, 25 (1990).

TABLE C
Parameters Used for TREF

| Parameter | Explanation |
|---|---|
| Column type and size | Stainless steel shot with 1.5 cc interstitial volume |
| Mass detector | Single beam infrared detector IR4 purchased from |
| | PolymerChar of Valencia, Spain |
| Injection temperature | 150° C. |
| Temperature control | GC oven |
| device | |
| Solvent | 1,2,4-trichlorobenzene |
| Flow Rate | 1.0 ml/min. |
| Concentration | 0.1 to 0.3% (weight/weight) |
| Cooling Rate 1 | 140° C. to 120° C. @ −6.0° C./min. |
| Cooling Rate 2 | 120° C. to 44.5° C. @ −0.1° C./min. |
| Cooling Rate 3 | 44.5° C. to 20° C. @ −0.3° C./min. |
| Heating Rate | 20° C. to 140° C. @ 1.8° C./min. |
| Data acquisition rate | 12/min. |

The data obtained from TREF are expressed as a normalized plot of weight fraction as a function of elution temperature. The separation mechanism is analogous to that of copolymers of ethylene, whereby the molar content of the crystallizable component (ethylene) is the primary factor that determines the elution temperature. In the case of copolymers of propylene, it is the molar content of isotactic propylene units that primarily determines the elution temperature.

One statistical factor that can be used to describe the crystallinity distribution of a propylene-based elastomer is the skewness, which is a statistic that reflects the asymmetry of the TREF curve for a particular polymer. Equation 1 mathematically represents the skewness index, Sᵢₓ, as a measure of this asymmetry.

$${S}_{ix} = \frac{\sqrt[3]{\sum {w}_{i} * {( {T}_{i} - {T}_{Max} )}^{3}}}{\sqrt{\sum {w}_{i} * {( {T}_{i} - {T}_{Max} )}^{2}}} . \qquad Equation 1$$

The value, Tₘₐₓ, is defined as the temperature of the largest weight fraction eluting between 50 and 90° C. in the TREF curve. Tᵢ and wᵢ are the elution temperature and weight fraction respectively of an arbitrary, i^{th} fraction in the TREF distribution. The distributions have been normalized (the sum of the wᵢ equals 100%) with respect to the total area of the curve eluting above 30° C. and less than 90° C. Thus, the index reflects only the shape of the crystallized polymer containing comonomer (ethylene) and any uncrystallized polymer (polymer still in solution at or below 30° C.) has been omitted from the calculation shown in Equation 1. In a particularly preferred aspect of the current invention have broad crystallinity distribution indicated by a skewness index for the propylene-based elastomer is greater than (−1.2), preferably greater than −1.0, more preferably greater than −0.8, and further more preferably greater than −0.7, and in some instances greater than −0.60. Such a skewness index is indicative of a propylene-based elastomer having a broad crystallinity distribution.

In addition to the skewness index, another measure of the breadth of the TREF curve (and therefore a measure of the breadth of the crystallinity distribution of a copolymer is the Median Elution Temperature of the final eluting quartile (T_{M4}). The Median Elution Temperature is the median elution temperature of the 25% weight fraction of the TREF distribution (the polymer still in solution at or below 30° C. is excluded from the calculation as discussed above for skewness index) that elutes last or at the highest temperatures. The Upper Temperature Quartile Range (T_{M4}-Tₘₐₓ) defines the difference between the Median Elution Temperature of the final eluting quartile and the peak temperature T_{Max}. In this particularly preferred aspect of the invention, the propylene-alpha olefin copolymers have broad crystallinity distributions indicated in part by an Upper Temperature Quartile Range of greater than 4.0° C., preferably at least 4.5° C., more preferably at least 5° C., further more preferably at least 6° C., most preferably at least 7° C., and in some instances, at least 8° C. and even at least 9° C. In general, higher values for the Upper Temperature Quartile Range correspond to broader crystallinity distributions for the copolymer. The Propylene-based elastomers utilized in the invention preferably exhibit broad crystallinity distribution fulfilling the above-described Upper Temperature Quartile Range.

Further, in this particularly preferred aspect, propylene-based elastomers comprise propylene-ethylene copolymers and show unusual and unexpected results when examined by TREF. The distributions tend to cover a large elution temperature range while at the same time giving a prominent, narrow peak. In addition, over a wide range of ethylene incorporation, the peak temperature, T_{Max}, is near 60° C. to 65° C. In conventional propylene-based copolymers, for similar levels of ethylene incorporation, this peak moves to higher elution temperatures with lower ethylene incorporation.

For conventional metallocene catalysts the approximate relationship of the mole fraction of propylene, Xₚ, to the TREF elution temperature for the peak maximum, T_{Max}, is given by the following equation:

Logₑ(Xₚ)=−289/(273+Tₘₐₓ)+0.74

For the propylene-based elastomers in this particularly preferred aspect, the natural log of the mole fraction of propylene, LnP, is greater than that of the conventional metallocenes, as shown in this equation:

LnP>−289/(273+Tₘₐₓ)+0.75

For propylene-based elastomers exhibiting a heat of fusion of less than 20 Joules/gram heat of fusion, broad crystallinity distribution preferably is indicated by either the determination of the high crystalline fraction (HCF) using DSC or by the determination of the relative composition drift (RCD) using GPC-FTIR. These analyses are performed as follows:

The High Crystalline Fraction, HCF, is defined as the partial area in the DSC melting curve above 128° C. The partial area is obtained by first obtaining the heat of fusion, then dropping a perpendicular at 128° C. and obtaining the partial area above 128° C. (relative to the same baseline as was used for the heat of fusion). The propylene-ethylene copolymers of the most preferred aspect of the current invention have a heat of fusion of less than 20 Joules/gram and have a HCF fraction of greater than about 0.1 J/g and an ethylene content of greater than about 10% by weight, more preferably the HCF will be greater than 0.2 J/g, and most preferably the HCF will be greater than about 0.5 J/g and an ethylene content of greater than about 10% by weight.

As an alternative or adjunct to the DSC method described above, the relative breadth of the crystallinity distribution for lower crystallinity copolymers can be established using GPC-FTIR methodologies [R. P. Markovich, L. G. Hazlitt, L. Smith, ACS Symposium Series: Chromatography of Polymers, v. 521, pp. 270-276, 199; R. P. Markovich, L. G. Hazlitt, L. Smith, Polymeric Materials Science and Engineering, 65, 98-100, 1991; P. J. DesLauriers, D. C. Rohlfing, E. T. Hsieh, “Quantifying Short Chain Branching in Ethylene 1-olefin Copolymers using Size Exclusion Chromatography and Fourier Transform Infrared Spectroscopy (SEC-FTIR)”, Polymer, 43 (2002), 159-170]. These methods, originally intended for ethylene based copolymers, can be readily adapted to the propylene based systems to provide copolymer composition as a function of polymer molecular weight. The propylene-ethylene copolymers exhibiting broad composition (with respect to ethylene incorporation) distributions, when measured as described in the GPC-FTIR method, have also been found to exhibit broad crystallinity distributions as indicated by high HCF values in the above described DSC method. For this reason, for the purposes of the current invention, composition distribution and crystallinity distribution shall be regarded as congruent, in that the relative breadth of the crystallinity distribution as indicated by the magnitude of the HCF value for a low overall crystallinity copolymer (that is. heat of fusion less than 20 Joules/gram) corresponds to a broader composition distribution as indicated by the magnitude of RCD (to be described below) measured by GPC-FTIR.

In one embodiment, the low crystallinity propylene polymer is used with at least one adhesion enhancer.

In most instances it is useful to enhance the adhesion of the low crystallinity propylene polymer to a substrate. This is accomplished by using adhesion enhancers, either internal or external, including inventive means described hereinafter. Exemplary of external adhesion enhancers are tie layers that can be used between the layer of low crystallinity propylene polymer and a substrate and primers that can be used on the low crystallinity propylene polymer or, preferably, on the substrate to which it is adhered. Tie layers often include such polymers as copolymers including graft copolymers of α-olefins, especially ethylene, with vinyl esters or acrylate or methacrylate esters such as methyl acrylate (EMA), methyl methacrylate and the like. A tie layer optionally and frequently comprises ethylene vinyl acetate (EVA), an ionomer such as the salt of ethylene acrylic acid, ethyl acrylic acetate, ethyl methacrylate (EMAC), metallocene-catalyzed polyethylene (m-PE), graft copolymers of ethylene polymers such as maleic anhydride grafts of ethylene polymers, PVB, including plasticized PVB and acoustic modified PVB, for instance and disclosed in JP-A05138840, ISD resins (U.S. Pat. Nos. 5,624,763 and 5,464,659), polyurethane, polyvinyl chloride (PVC) including plasticized PVC and acoustic modified PVC (for instance that of U.S. Pat. No. 4,382,996, available from Sekisui KKKK, Osaka, Japan, further described in interlayer films of U.S. Pat. No. 5,773,102), and combinations thereof, with tie layers containing copolymers comprising ethylene and at least one polar comonomer preferred, and ethylene copolymers with vinyl acetate more preferred. Materials adherent to mineral glass without the application of a primer, such as EVA, are preferred tie layers herein because they reduce the cost and complexity of the resulting laminate. Transparent, non-yellowing, temperature and light stable grades of these resins are preferred. When used as an adhesive polymer, the ethylene content of EVA is preferably at least about 15, more preferably at least about 18, most preferably at least about 25 and preferably at most about 32, more preferably at most about 28 based on total weight of monomers in the EVA.

When the tie layer is an EVA, the interlayer film is preferably co-extruded in an NB (EVA/interlayer) or A/B/A (EVA/interlayer/EVA) configuration to form a laminated film. The EVA film alternatively may be extruded separately, or cast into a film, using various film processing techniques, including those extrusion processes described herein for the interlayer film. Suitable EVA resin for optical laminate interlayer films may be obtained, for instance, from Bridgestone Corporation, Tokyo, Japan, Exxon Corporation, Baytown, Tex., and from Specialized Technologies Resources, Inc., Enfield, Conn., for instance EVA polymers commercially available from DuPont under the trade designation Elvax 3134, 3150, 3170, 3174, 3175 and 3190. Similarly, other tie layer polymers are commercially available such as salts of ethylene/methacrylic acid commercially available from DuPont under the trade designation Surlyn 1705 and 1802 or from Arkema under the trade designation Lotryl 28MA07.

Selection of the relative thickness ratios of the interlayer, the tie layer or layers and the material or materials laminated thereto is within the skill in the art should be selected so as to optimize the combination of desired properties of adhesion, weight, penetration resistance, acoustical barrier, security barrier and the like. Within these constraints, a thickness of the tie layer of is often advantageously at least about 0.01 mm, more preferably at least about 0.03 mm, most preferably at least about 0.05 mm for a glazing laminate. Conveniently, a tie layer is at most about 1 mm, preferably at most about 0.5 mm, most preferably at most about 0.3 mm thick for most applications. A tie layer is preferably at least about 3, more preferably at least about 4 and preferably at most about 10, more preferably at most about 8, most preferably at most about 7 percent of the thickness of an adjacent interlayer film.

Another type of external adhesion enhancer is primers, compounds or compositions that can be applied to one or more surfaces of a substrate or interlayer film to improve adhesion between them. Especially in the case of glass substrates, primers are commonly used to provide polarity to bond to the glass and chemical functionality that forms ionic, or preferably chemical bonds with a polymer to be bonded thereto. Exemplary primers include silanes, siloxanes, titanates, and combinations thereof, preferably vinyl-triethoxysilane, amino-propyl-triethoxysilane, and combinations thereof, many of the same compounds that are also useful as coupling agents when admixed with an interlayer film composition.

Yet another embodiment of external adhesion enhancers is surface treatment of an interlayer film, for instance by corona discharge which is within the skill in the art, for instance as taught by Sonoda and Osada in application number JP2004-276947 in which they treat a film of polyesters and copolyesters with corona discharge and then utilize coating of polyester/melamine crosslinker/SiO₂ liquid to effect adhesion. Corona treatment is believed to result in functionality on the surface of a film. This functionality can be useful in adhering to substrates especially polar, preferably polar organic, materials such as polycarbonates, acrylates, and methacrylates.

Coupling agents, as previously defined, are a preferred class of adhesion enhancers. In many instances they are also chemically involved in crosslinking which results in lower haze after processing, for instance laminating, at temperatures sufficient to result in crystal formation; thus, they are also clarity enhancers. These compounds, like the primers, have at least one molecular moiety that adheres to glass, such as a silane or titanate group and at least one other organic moiety that is compatible with and is bondable to or increases the adhesion to at least one polymer in the interlayer film composition. The preferred coupling agents are capable of chemically reacting with both the substrate and at least one polymer in an interlayer composition. Examples of this type of reactive coupling agent include vinyl alkoxy silanes such as vinyltrimethoxy silane, vinyltriethoxy silane and combinations thereof. The vinyl functionality of these coupling agents can be grafted to olefin polymers using a small amount of peroxide to initiate free radicals. Alkoxy silane functionality is retained after exposure to the peroxide and allows moisture initiated bonding to hydroxyl functionality on a substrate such as mineral glass, crosslinking or a combination thereof. The crosslinking helps prevent crystal growth in the polymers and therefore inhibits increased haze with time. The concentration of the coupling agent in the composition of the invention is advantageously at least sufficient to improve adhesion of the interlayer to the substrate immediately adjacent to it, advantageously at least about 0.5, more advantageously at least about 1.0, preferably at least about 1.2, more preferably at least about 1.4, most preferably at least about 1.6 weight percent based on the weight of polymers in an interlayer composition. In most embodiments, the amount is preferably at most about 3, more preferably at most about 2.5, most preferably at most about 2 weight percent based on weight of polymers in a composition because that is sufficient for the purpose of the invention. Additional coupling agent increases the cost of the system, increases the amount of crosslinking that occurs due to a small amount of water that may permeate into the polymers during processing.

The use of coupling agents, especially silane coupling agents, is preferably accompanied by use of crosslinking agents or other introduction of free radicals. Although the invention is not to be limited to the correctness of these beliefs, it is believed that the crosslinking agents or other radical source results in reaction of the coupling agents with the polymer or polymers present such that the coupling agent and polymer are bonded together, also referred to herein as grafted. Such bonding is believed to enhance the effectiveness of the coupling agents.

Optionally a catalytic quantity of accelerator for the non-vinyl functionality of a coupling agent having a vinyl functional group and another non-vinyl functional group is used. An accelerator is a catalyst, which is optionally and advantageously used with vinyl alkoxy silanes to accelerate the reaction of the alkoxy silane with water. In the case of vinyl functional siloxanes such as vinyl trimethoxy silane or vinyl triethoxy silane, the catalytic accelerator is a tin compound such as dibutyl tin dilaurate. Catalytic quantities are those quantities which increase the reaction rate of moisture that absorbs into the sheet during the lay-up of the laminate such that moisture results in crosslinking of the sheet and bonding to the substrate during the glass lamination process, preferably at least about 10, more preferably at least about 20, most preferably at least about 30 and preferably at most about 300, more preferably at most about 200, most preferably at most about 100 parts per million by weight (ppm) based on total weight of the interlayer composition.

Either in the presence of coupling agents or in their absence, materials are optionally and preferably added or processes used or a combination thereof to achieve a desired degree of crosslinking when doing so improves clarity, haze, adhesion, other desired property or a combination thereof. These materials, compounds or compositions are referred to hereinafter as crosslinking agents. Crosslinking can avoid or diminish haze formation by reducing the tendency of the interlayer composition to crystallize such that haze results. Thus, crosslinking agents and crosslinking radiation are clarity enhancers. This crystallization can take place in the initial formation of the film or after exposure to such conditions as heat, pressure or a combination thereof, for instance, in formation of a laminate. The temperatures and pressures often used in formation of safety glass using PVB interlayers, for instance, may be in the range of 110-185° C., with pressures above atmospheric, possibly for several hours. Such conditions are sufficient to result in recrystallization of polyolefins that are not crosslinked.

Use of a reactive coupling agent such as vinyl alkoxy silane that undergoes an amount of reaction during processing results in a formulation less prone to stickiness or blockiness. This makes the material easier to process and may eliminate the need for release sheet to allow unrolling a sheet or film during use.

Crosslinking is optionally accomplished by any method within the skill in the art. Such methods as coupling with azide compounds such as sulfonyl azides or combinations thereof such as are disclosed in such references as U.S. Pat. No. 6,143,829, which is incorporated by reference to the extent permitted by law, organic peroxides such as dicumyl peroxide, di-t-butyl peroxide, or combinations thereof, azo compounds such as azobis isobutyronitrile (AIBN), azides such as sulfonyl azides, or by interaction with radiative energy such as ultraviolet (UV), e-beam, or gamma radiation and the like, such as are disclosed in Peter Dluzneski, “Peroxide Vulcanization of Elastomers” in Rubber Chemistry and Technology, Volume 47, pp. 452-490, (1974) are suitable. Such methods as peroxide, peroxide silanol, UV initiated, azide, diazo crosslinking and combinations thereof are preferred, with peroxide the preferred crosslinking agent. The peroxide is preferably an organic peroxide. Suitable organic peroxides have a half life of at least one hour at 120° C. Illustrative peroxides include a series of vulcanizing and polymerization agents that contain α, α′-bis(t-butylperoxy)-diisopropylbenzene and are available from Hercules, Inc. under the trade designation VULCUP™, a series of such agents that contain dicumyl peroxide and are available from Hercules, Inc. under the trade designation Di-cup™ as well as Lupersol™ peroxides made by Elf Atochem, North America or Trigonox™ organic peroxides made by Akzo Nobel. The Lupersol™ peroxides include Lupersol™ 101 (2,5-dimethyl-2,5-di(t-butylperoxy)hexane), Lupersol™130 (2,5-dimethyl-2,5-di(t-butylperoxy)hexyne-3) and Lupersol™575 (t-amyl peroxy-2-ethylhexonate). Other suitable peroxides include 2,5-dimethyl-2,5-di-(t-butyl peroxy)hexane, di-t-butylperoxide, di-(t-amyl)peroxide, 2,5-di(t-amyl peroxy)-2,5-dimethylhexane, 2,5-di-(t-butylperoxy)-2,5-diphenylhexane, bis(alpha-methylbenzyl)peroxide, benzoyl peroxide, t-butyl perbenzoate, 3,6,9-triethyl-3,6,9-trimethyl-1,4,7-triperoxonane and bis(t-butylperoxy)-diisopropylbenzene.

Crosslinking can take place, before or after film formation. For instance, peroxide crosslinking typically takes place by incorporating the peroxide into the polymer and treating the mixture such that the polymer melts. Typically this treatment is at temperatures that also induce thermal activation of the peroxide, leading to radical formation in the polymer. This treatment can be performed as part of the process of forming the molten polymer into a film by extruding the melt through a die. Radiation crosslinking frequently is accomplished by exposure of a formed film to radiation, such as UV radiation. Alternatively, radiation is used with a crosslinking agent that is active in the presence of radiation. Such crosslinking agents include, for instance, photoinitiators which are well within the skill in the art and commercially available, such as bisacyl phosphine oxide commercially available from Ciba Specialty Chemicals under the trade designation Irgacure 819 photoinitiator.

Peroxide crosslinking is preferred because of the relative ease of incorporating organic peroxides into the polymers of this invention, and the ability of the peroxide to induce both crosslinking of the polymer and grafting of the coupling agent. In peroxide crosslinking, a peroxide, preferably an organic peroxide such as dicumyl peroxide, commercially available from Arkema under the trade designation Dicup, Di(2-t-butylperoxyisopropyl)benzene commercially available from Arkema under the trade designation Vulcup, 1,1-di(t-butylperoxy)-3,3,5,trimethylcyclohexane, commercially available from Akzo Nobel under the trade designation Triganox 29, 2,5-dimethyl-2,5-di(t-butylperoxy)hexane, commercially available from Arkema under the trade designation Luperox 101, is incorporated into the composition of the invention. The amount of peroxide is carefully controlled and mixing is uniform to avoid increase haze, gel content or a combination thereof. The concentration of the crosslinking agent in the composition of the invention is advantageously at least sufficient to improve adhesion of the interlayer to the substrate immediately adjacent to it or to improve haze or a combination thereof, advantageously at least about 0.1%, more advantageously at least about 0.5%, preferably at least about 1%, and preferably at most about 3, more preferably at most about 2 weight percent based on total weight of the composition of the invention. Excess peroxide may result in brittleness.

After the peroxide is incorporated into the composition it is treated at temperature sufficient to bring about substantially complete conversion of the peroxide into active radical species. The time and temperatures are commonly determined based on the half life of the peroxide. The peroxide half life is determined as the time required for half of the peroxide to react during thermal treatment, and is temperature dependant. Different organic peroxide structures have different half lives at the same temperature, such that the choice of peroxide and the temperature used for processing the polymer are chosen coincidentally. For a given peroxide, a time of treatment at temperature roughly equal to 6 half lives is desirable to obtain substantially complete conversion of the peroxide.

In peroxide-silanol crosslinking, a combination of peroxide and a vinyl alkoxy silane, such as vinyl trimethoxy silane, vinyl triethoxy silane or a combination thereof, is admixed with the composition of the invention. Mixing, for instance, in an extruder, film formation, or a combination thereof, provide sufficient heat for the peroxide to graft the vinyl functionality of the vinyl alkoxy silane to the polymer chain. This grafting of the vinyl functionality of the vinyl alkoxy silane to polyolefin polymer chains occurs in situ during mixing and extrusion and leaves the majority of the siloxane functionality for crosslinking or bonding to a polar substrate, preferably an inorganic polar substrate, more preferably mineral glass, a metal or a combination thereof, most preferably mineral glass. Water treatment of the film is used to achieve crosslinking. Water is optionally supplied by steam treatment, contact with hot, optionally boiling, water or the like to accelerate crosslinking, but these are seldom needed. Interlayer films of the invention are, in most instances sufficiently water permeable that providing adequate moisture for crosslinking and bonding to a substrate requires only exposure to atmospheric moisture (preferably at least about 50 percent relative humidity) to initiate bonding to glass. Protection by bagging and handling in moisture impermeable packaging, such as foil or foil-lined bags or storage in dehumidified areas to avoid premature crosslinking from atmospheric moisture is sometimes advisable until crosslinking, coupling to substrate or both is desired. Combinations of peroxide and silanol are available in concentrates, such as a concentrate commercially available from OSI Corp. under the trade designation SILCAT. Compositionally, these concentrates are primarily the vinyl alkoxy silane with just enough peroxide to initiate the free radical grafting reaction. Such concentrates typically contain a small amount of a tin catalyst such as disobutyl tin dilaurate which accelerates reaction of the alkoxy silane functionality with water. Therefore, the concentrates are preferably used in amounts corresponding to the advantageous and preferred amounts of coupling agents previously disclosed herein.

While vinyl silane compounds are particularly useful in bonding or adhering to glass and other inorganic substrates, bonding or adhering to organic substrates like polycarbonate, acrylate or methacrylate polymers is preferably accomplished using tie layers or other means within the skill in the art. For instance, the low crystallinity propylene polymer and the optional blends with clarifying polymers can be grafted with maleic anhydride to increase hydrogen bonding and therefore adhesion to more polar polymers.

In one embodiment, at least one low crystallinity propylene polymer is admixed (also referred to as blended) with at least one additional polymer which preferably acts as either a clarity enhancer, an adhesion enhancer or a combination thereof. When clarity is desired, it is preferred that the refractive indices of each polymer in the resulting blend be sufficiently close to avoid increasing haze. When the resulting polymer blend has a haze lower than that of the low crystallinity propylene polymer, the additional polymer or polymers are referred to herein as clarifying polymers although use of such a polymer is often observed to improve both haze and adhesion; therefore it is both a clarity enhancer and a adhesion enhancer. Preferred clarifying polymers include the ethylene/alpha-olefin polymers previously described as VLDPE, ULDPE, homogeneous ethylene polymers, and substantially linear ethylene polymers or combinations thereof, more preferably the homogenous ethylene polymers, most preferably the substantially linear ethylene polymers. Other useful clarifying polymers include polybutenes, atactic polypropylene and polymers of other higher olefins such as poly(4-methyl-1-pentene). This latter material is commonly abbreviated as PMP and is know to have exceptional optical clarity, similar to polystyrene and acrylics and compatibility with other lower polyolefins.

When optical clarity is desired, the clarifying polymer advantageously has a refractive index near that of the low crystallinity propylene polymer. The refractive indices of the clarifying polymer and low crystallinity propylene polymer are advantageously within about 0.2, more advantageously within about 0.1, preferably within about 0.05, more preferably within about 0.03, most preferably within about 0.01 of each other. When the polymers do not have similar refractive indices, the resulting haze will be higher than that of either polymer alone. When the refractive indices of the two polymers are properly matched, the haze of the resulting blend has a haze equal to or less than the average haze of the components, that is, the low crystallinity propylene polymer or polymers and the clarifying polymer or polymers. The resulting blend of low crystallinity propylene polymer or polymers and the clarifying polymer or polymers also advantageously has a refractive index similar to that of the glass used in a laminate. The refractive indices of adjacent polymer compositions (for instance between tie layer and interlayer film), between polymer composition and glass or a combination thereof are advantageously within about 0.2, more advantageously within about 0.1, preferably within about 0.05, more preferably within about 0.03, most preferably within about 0.02 of each other. Because there are only one or two interfaces of the interlayer composition and glass or other transparent substrate, possibly more when there are tie layers or more than one interlayer film, the refractive index match between interlayer and substrate is not nearly as important as between the two polymers because within an interlayer there may be several orders of magnitude more interfaces between domains of different polymers making up the interlayer. Admixing a clarifying polymer with a low crystallinity propylene polymer frequently changes the crystallizing behavior of one or both polymers, for instance when it reduces growth of large crystals. Comparison of a series of polymer systems including additives and enhancers to be used therewith is optionally used to select among combinations of polymers having similar refractive indices when measured individually. When comparing a series of polymer blends is desired and the clarifying polymer is an ethylene polymer, it can be useful to select ethylene polymers having a density as close as possible to that of the low crystallinity propylene polymer. For this reason the density of the clarifying polymer preferably within at most about 0.05 g/cm³, more preferably at most about 0.03 g/cm³, most preferably at most about 0.02 g/cm³ of the density of the low crystallinity propylene polymer.

The amount of clarifying polymer in a composition or film of the invention is advantageously at least about 10, more advantageously at least about 15, most advantageously at least about 20, preferably at least about 30, more preferably at least about 35, most preferably at least about 40 and at most about 80, more advantageously at most about 75, preferably at most about 70, more preferably at most about 65, most preferably at most about 60 weight percent based on total weight of the resulting composition or film.

The combination of clarifying polymer and low crystallinity propylene polymer is optionally used with one or more tie layers, or preferably used without a tie layer. The combination is also optionally and preferably used with one or more coupling agents and independently optionally and preferably with crosslinking agents as discussed previously.

Various additives are advantageously used with the low crystallinity propylene polymer or combination thereof whether or not at least one clarifying polymer is used, to form the interlayer composition. The type and identity of additives depend on the type and end use of the interlayer produced. The interlayer composition advantageously contains at least one UV light stabilizer or absorber, or combination thereof. The UV light stabilizer is preferably hindered amines, benzophenones and benzotriazoles, more preferably the latter for absorbing UV light. UV light stabilizers and absorbers are commercially available and include 2-hydroxy-4-methoxybenzophenone commercially available from American Cyanamid under the trade designation Cyasorb UV 9, poly[2-N,N′-di(2,2,6,6-tetramethyl-4-piperidinyl)-hexanediamine-4-(1-amino-1,1,3,3-tetramethylbutane)symtriazine] commercially available from Ciba Specialty Chemicals, Inc. under the trade designation CHIMASORB 944, and polymerizable benzotriazole, commercially available from Noramco Corporation (USA) under the trade designation NORBLOCK™ absorber or a combination thereof. The concentration of the UV light stabilizer in the composition of the invention is advantageously at least sufficient to reduce the effects of UV light, advantageously at least about 100 ppm more advantageously at least about 200, preferably at least about 300, more preferably at least about 500 and preferably at most about 2000, more preferably at most about 1000, most preferably at most about 750 ppm (parts per million) based on total weight of the composition of the invention. Excess UV light stabilizer can phase separate from the polymer, leading to increased haze, or migrate to the film surface, compromising adhesion. Some UV light stabilizers absorb UV light and, thus, when in an interlayer exposed to a source of UV light, such as the sun, on one side, protect things on the opposite side of the interlayer from UV light. This is useful for protecting contents or interiors of cars and buildings, solar cells or electronics of photovoltaics and the like from UV rays.

Additionally other additives such as IR light blockers for reducing transmission of IR light, pigments, dyes or colorizing agents, (for architectural, decorative or other colored applications), additives to increase reflection of the laminate, decrease blocking of the film, particulates, other additive within the skill in the art or combinations thereof are optionally used. Pigments, dyes, and/or color concentrates may be added when special color effects are needed for instance for architectural, decorative and other applications. They are used in such concentrations as are determined by coloration technology.

A nucleation agent is optionally, but not preferably, added to improve optical properties and clarity; to reduce the haze of the film, or to stabilize the morphological structure of the material or a combination thereof. Incorporation of a nucleation agent is believed to help reduce the dimensions of crystal units and provide stability after reheating of the film during lamination or after exposure to sun or other sources of heat.

Such additives as plasticizers that are known to bleed out of the polymer resulting in undesirable effects as bubbles between an interlayer film and adjacent substrate, reductions in clarity, increase in haze, undesirable reductions in adhesion between interlayer film and substrate or a combination thereof are preferably avoided (substantially absent).

In one embodiment, at least one internal adhesion enhancer or at least one clarity enhancer is admixed with at least one low crystallinity propylene polymer and any additives or additive package used, in any sequence and by any means within the skill in the art, for instance, by mixing in a melt compounding extruder, such as a twin screw extruder, a batch mixer, such as a Banbury, Haake, or Brabender mixer, a continuous mixer and the like. At least one adhesion enhancer or clarity enhancer or both are optionally polymeric, for instance a clarifying polymer. Substantially uniform mixing of the polymers and additives is highly preferred. One or more of the additives is optionally used as a concentrate in an ethylene or propylene polymer or other polymer compatible with the polymers used in the composition of the invention. In general, a composition of the invention is formed in a process comprising (a) supplying at least one first component, a low crystallinity propylene polymer, (b) supplying at least one second component, selected from at least one an internal adhesion enhancer, at least one clarity enhancer or a combination thereof; and, (d) admixing the first and second components and optional additives. For convenience, the compositions are optionally and preferably pelletized by any means within the skill in the art. In one embodiment, the compositions of the invention are conveniently mixed in an extruder with a die from which strands are extruded. The strands are optionally cooled and cut into pellets. Alternatively, the components are admixed in one or more extruders from which the resulting admixture is extruded into a film or into a shape from which a film is formed, for instance a tube or sheet.

In one embodiment wherein the interlayer composition comprises a blend of at least one clarifying polymer and at least one low crystallinity propylene polymer, a two phase morphology is optionally created wherein one phase is dispersed in the other continuous phase. In some instances, the two phases are co-continuous. Although the presence of two phases adds complexity and may increase the advisability of close refractive indices when high clarity and low haze are particularly important, it also makes it possible achieve clarity with one phase and penetration resistance with the other. These two phases are advantageously created with a combination of distributive mixing and dispersive mixing or shear. Means of achieving these types of mixing are advantageously achieved as previously outlined. In a preferred embodiment, a twin screw co-rotating mixer, counter-rotating mixer, or kneader is used. Such mixers are commercially available. Control of the combination of distributive mixing and dispersive shear is achieved by selection of the elements utilized to stack the screw. More preferably the mixing includes use of a sequence of at least 2, preferably 3, of conveying elements, kneading elements or blocks, and reversing elements. This advantageously results in a combination of distributive and dispersive mixing, melting, and air elimination. Where the liquid is injected into the extruder, the use of gear elements is advantageous. The purpose of reversers is to form a melt seal so that a vacuum can be maintained in the extruder. Finally, conveyance elements are used to build up pressure using a drag flow mechanism so that the combined die receiving layer can be extruded through a die. If there is insufficient distributive mixing the dispersed phase will be inconsistently distributed in the continuous phase. If there is insufficient dispersive shear, the particle size of the dispersed phase may be so large and variable that adhesion to the glass or the clarifying effect of the clarifying polymer is inconsistent across the area of the laminate.

While adhesion enhancers, some clarity enhancers and some other additives are conveniently admixed with polymer compositions in the extruders in which polymers are conveniently mixed, melted or a combination thereof, others are liquids. For instance, adhesion enhancer preferred coupling agents and initiators are liquids that are conveniently admixed with polymers in comminuted form. For instance, liquids are conveniently tumbled with polymer pellets, preferably that have been pre-compounded with other polymers of the composition.

In another embodiment, the low crystallinity propylene polymer, optionally in combination with additives, clarity enhancer, internal adhesion enhancer, or a combination thereof is coextruded with an external adhesion enhancer to form a film. Alternatively, an external adhesion enhancer is coated onto the interlayer film, laminated thereto or otherwise supplied directly adjacent to an interlayer film by any means within the skill in the art.

The interlayer composition is advantageously formed into a film by any film forming process within the skill in the art, including blown and cast film methods. Thus, the process to make an interlayer film of the invention comprises (a) mixing components of the interlayer compositions and (b) extruding them to be cast or blown into a film. In one embodiment casting the film is preferred. A film is cast in a process comprising the steps of (a) supplying a composition of the invention to an extruder to form an admixture, (b) extruding the admixture into a flat film. The process optionally and preferably additionally includes at least one of (c) cooling the film, (d) rolling the film onto at least one roller or a combination thereof. In one embodiment, when the film is to be cured or adhered to glass using moisture, there is an optional step of protecting the film from moisture until exposure thereto is desired.

The film is of any thickness appropriate for its intended use. Present processes for making automotive, train, or architectural glass or plastic laminates often utilize a thickness of advantageously at least about 0.1 mm more advantageously at least about 0.15 mm, preferably at least about 0.2, more preferably at least about 0.3, most preferably at least about 0.4 and preferably at most about 1, more preferably at most about 0.75 mm. However, there are various reasons to expand these preferred ranges. In some end uses, for instance, if it is desirable to reduce the thickness of the interlayer to reduce cost, reduce haze, reduce weight or a combination thereof. This can be accomplished if the interlayer has sufficient penetration resistance for the intended use and sufficient integrity for handling in a laminating process. In other situations it is desirable to use a thicker interlayer than is now commonly used to reduce the thickness of glass, to achieve greater flexibility, cushioning, thermal insulation, sound absorption, security, penetration resistance or a combination thereof or other properties attributable to the interlayer. To achieve this it is important for the interlayer to have particularly low haze where appropriate for the end use. For these purposes, a thickness is advantageously at least about 0.1 mm, preferably at least about 0.25 mm, more preferably at least about 0.4 mm, and preferably at most about 5 mm, more preferably at most about 2 mm, most preferably at most about 1 mm.

An interlayer film product according to the present invention is optionally smooth-surfaced or alternatively, it optionally has a roughened surface, for instance embossed patterns on its surface which is believed to assist the evacuation of air between the interlayer film and a substrate during lamination which is within the skill in the art such as taught by Smith and Anderson in US 20060141212. The film optionally has embossed patterns on one or both sides made with an embossing roll. Patterns additionally or alternatively are optionally using an extrusion die with a specific design profile. Furthermore, it is sometimes desirable to have printing on an interlayer film. The interlayer film is optionally treated to improve printability or other surface properties by treatments within the skill in the art such as corona treatment.

While the compositions and films of the invention are particularly useful as interlayers between two or more sheets or panels of mineral or polymer glass, to form such articles as safety glass, side window glazing, windshields, windscreens, protective shields, bullet resistant glass, windows, green houses and the like they are not limited to this use. They are, for instance also useful in forming laminates such as photovoltaic cells where one surface or substrate through which light would be received would be transparent and the other would be the solar cell. Such items as panels or sheeting for greenhouses or screens for electronics such as televisions or other viewing screens can have two layers of substrate with an interlayer of the invention or one layer or substrate with a layer of the invention, the latter possibly being thicker or stiffer to provide needed properties for handling and service. Among these uses of the film of the invention as an interlayer between polymer or mineral glass layers, the film of the invention is particularly useful in hurricane glass, that is glass which meets the requirements of such as ASTM C1172 for laminated architectural flat glass or EN ISO 12543, ASTM F1642-95 air blast loading test for use in areas subject to hurricanes to withstand the forces of certain hurricanes. The interlayer has superior penetration resistance to allow hurricane glass made therefrom to pass a test where a standard 2 by 4 board (about 4 cm×9 cm) is shot from a cannon into the glass. The low crystallinity propylene polymer interlayer films of the invention are superior to PVB in applications like hurricane glass and shower stalls where exposure to water is expected and it is difficult to achieve and maintain adequate seal to prevent moisture contact with the PVB at the edge of the laminate. Moisture contact results in development of haze. Maintaining sufficient seal is difficult in most architectural applications.

The films are optionally bonded to one or more layers of materials other than mineral or polymer glass, such as polystyrene, polyethylene terephthalate, poly(4-methyl-1-pentene) often abbreviated as PMP or combinations thereof to form optically transparent laminates. The films are optionally laminated on only one side (surface or face) to a glass or transparent polymer sheet to make protective cover sheets for articles such as TV or computer screens. Such laminates are suitable for further lamination or adhesion to other substrates and combinations thereof. Also, clear films that undergo crosslinking at ambient conditions due to moisture in the air, have a wide variety of applications such as the windows or skylights of large tents.

Thus, laminates of the invention include at least one interlayer film of the invention comprising a low crystallinity propylene polymer and at least one layer or substrate which is advantageously transparent or rigid, that is sufficiently stiff or rigid not to drape over the hand. At least one layer of substrate is preferably transparent. In the preferred embodiment where the interlayer of the invention is used between a first and a second substrate, at least one, the first substrate, is preferably transparent. In one preferred embodiment, the second substrate is also transparent and more preferably same material as the first substrate. In another preferred embodiment, the second substrate absorbs light (light absorptive), for instance as is useful for a photovoltaic cell. In a third embodiment, at least one substrate is reflective of light, for instance as is useful for a mirror. In a third embodiment the interlayer is a protective layer adhered to only one substrate. While interlayer films of the prior art often too moisture sensitive, sticky, or otherwise inappropriate to be exterior layers, interlayer films of the invention can be suitably used for exterior layers. For instance, after curing, such interlayer films as the moisture cured interlayer films lose their adhesiveness. Alternatively, a tie layer can be used as adhesion enhancer to one substrate and omitted on the opposite side of the interlayer film. In another embodiment, a first substrate is stiff or rigid, and a second substrate is a removable backing for subsequent removal and further lamination.

Laminates of the invention optionally have any number of layers. For instance, security or high performance laminates such as jet windshields optionally have layers such as acrylic polymers, fiber glass, silicone layers, polycarbonate sheets, polyurethane layers, and stabilizing bars. From 4 to 8 layers or more are common. The interlayer films of the invention are suitably contiguous to any one or more of the layers, preferably between at least 2 layers. In a single multilayer laminate, the interlayer film of the invention suitably takes any position, from being an outer layer, particularly if the laminate is to be further adhered to another material to being interspersed between each combination of layers in a multilayer laminate. Symbolically where the interlayer film of the invention is represented by F, glass by G, tie layers by T, other polymers by P and electronics such as solar cells, liquid crystal displays, memory cells and the like by E exemplary combinations include: G/F, G/T/F, P/F, P/T/F, E/F, E/T/F, G/F/G, G/T/F/G, P/F/G, P/T/F/G, E/F/G, E/T/F/G, G/F/T/G, G/T/F/T/G, P/F/T/G, P/T/F/T/G, E/F/T/G, E/T/F/T/G, G/F/P, G/T/F/P, P/F/P, P/T/F/P, E/F/P, E/T/F/P, G/F/T/P, G/T/F/T/P, P/F/T/P, P/T/F/T/P, E/F/T/P, E/T/F/T/P, G/F/G/F/G, G/F/P/F/G, G/T/F/T/G/T/F/T/G, G/T/F/T/P/T/F/T/GP/F/, P/T/F/E, P/T/F/T/E, E/F/P/F/G, E/T/F/T/G, G/F/P/P/G, G/F/P/P/F/P, G/T/F/P/P/P/P, G/T/F/P/T/P/F/P/P, and variations thereof, particularly where there are two or more directly adjacent layers in the same category such as two or more directly adjacent layers of the interlayer film of the invention, G/F/F/G, G/T/F/F/T/G and the like, wherein the layers represented by the same letter are optionally independently selected from the same or different compositions within the category represented. Examples of laminates within the skill in the art are described, for instance, in such references as R. Terrel Nichols and Robert Sowers, “Laminated Materials, Glass,” Kirk-Othmer Encyclopedia of Chemical Technology, John Wiley & Sons, Inc., Copyright 1995, posted online Dec. 4, 2000 as DOI: 10.1002/0471238961.1201130914090308.a01.

The interlayer films of the invention, advantageously have total energy in tear mode, of advantageously at least about 0.3, more advantageously at least about 0.4, preferably at least about 0.5, more preferably at least about 0.6, most preferably at least about 0.65 Newton meters (N m).

The interlayer films of the invention, advantageously have adhesion as measured by T peel strength sufficient to avoid premature delamination but not great enough to lose benefits of energy absorption, that is of preferably at least about 0.1, more preferably at least about 0.3, most preferably at least about 0.5 and advantageously at most about 5, preferably at most about 4, more preferably at most about 2, most preferably at most about 1 Newton/mm.

The interlayer films of the invention, would ideally have no internal haze but in practicality have as little as possible when used in windows or other applications where visibility through the laminate is important, that is of advantageously at most about 10%, more advantageously at most about 5%, preferably at most about 2%, more preferably at most about 1%, most preferably at most about 0.5 percent.

The interlayer films of the invention advantageously have adhesion to glass sufficient to form laminates to the glass of interest but not great enough to unacceptably limit the interlayer from involvement in reducing penetration.

When used for a security barrier, the interlayer films of the invention, advantageously have elastic modulus sufficient to avoid breakage in the situations for which they are designed, that is preferably an elastic modulus of at least about 25,000 psi (173 MPa), more preferably at least about 30,000 psi (207 MPa) as well as having a high penetration resistance.

The interlayer films of the invention, advantageously have tan delta sufficient to dampen sound waves, that is a tan delta value of advantageously at least about 0.1 and preferably at most about 0.6, provided the materials where they are found to help control the aesthetic quality of the transmitted sound (that is, sharpness value, loudness and Articulation Index), preferably at the service temperature.

The interlayer film of the invention can be laminated with glass or another substrate by any means within the skill in the art for instance by processes conventionally used to form safety glass using PVB interlayers. Such methods often include slow heating to temperatures of from 100° C. to 185° C., for instance over a period of 30 minutes to 2 hours, maintenance of the highest temperature for a period of 30 minutes to 2 hours, and slow cooling back to ambient temperatures, again over a period of from 30 minutes to 2 hours all in a vacuum bag to exclude moisture and in an autoclave under increased pressures of up to about 150 psi (1034 kPa). Such processes, however, consume large amounts of energy and time.

While the interlayers of the invention are suitable for use in these prior art methods, they enable new methods of making glass laminates, particularly safety glass. Interlayer films of the invention do not require the vacuum bag and autoclave conditions including long periods of time at high temperatures and pressures that are required for PVB interlayers. For instance when moisture curing adhesion enhancers, such as siloxanes, are used, the interlayer films of the invention can laminate to a substrate at room temperature over an extended period of time. However, it is usually preferable to supply heats sufficient to soften the interlayer composition (including the tie layer when used as adhesion enhancer) adjacent the substrate to achieve polymer melting enough to fill irregularities in the contacted surface of the substrate for improved adhesion. This heat also hastens crosslinking and coupling with the substrate. It is also frequently useful to apply pressure at least for a brief period of time, for instance as a roller is rolled over the combination of interlayer and substrate. Vacuum or other reduction in air pressure can be useful to avoid entrapment of air between a substrate and directly adjacent layer. The amount of heat, pressure and time are interdependent, but those skilled in the art are well able to achieve a desirable combination without undue experimentation. Thus, the interlayers of the invention are preferably laminated by processes including the steps of (a) positioning at least one layer of the interlayer film directly adjacent to at least one layer of substrate (b) applying sufficient heat or other energy to result in softening of the interlayer directly adjacent the substrate with simultaneous application of sufficient pressure to press polymer into intimate contact with substrate. In some embodiments, pressure is advantageously applied for less than about 30 minutes, more advantageously less than about 20 minutes, preferably less than about 15 minutes, more preferably less than about 10 minutes, most preferably less than about 5 minutes. Similarly, energy use is optionally reduced by applying heat for periods of time sufficient to melt and result in adhesion but advantageously less than about 60 minutes, more advantageously less than about 45 minutes, preferably less than about 30 minutes, more preferably less than about 20 minutes, most preferably less than about 15 minutes. The process optionally includes a step of (c) cooling the resulting laminate to ambient conditions, which step is optionally accomplished by exposure to ambient temperature.

The laminates of the interlayer films of the invention between two layers of glass, advantageously have penetration resistance sufficient to avoid penetration of any object which the laminate would reasonably be expected to encounter in normal use. Such resistance is seldom practical or supplied by the interlayer alone, therefore, in safety glass applications such as automobile windshields the penetration resistance is preferably at least about 6 m, more preferably at least about 8 m, most preferably at least about 9 m as determined by the ball drop test.

Such laminates of interlayer films of the invention with optically transparent materials such as glass, would ideally have no total haze or a minimum of haze equivalent to that of the glass used in the laminate, but in practicality have as little as possible when used in windows or other applications where visibility through the laminate is important, that is of advantageously at most about 11%, more advantageously at most about 6%, most advantageously at most about 3%, preferably at most about 2%, more preferably at most about 1%, most preferably at most about 0.6%.

A laminate of the invention, that is a laminate of the interlayer film of the invention with at least one mineral or plastic glass layer, advantageously has acoustic barrier properties at least equivalent to glass of the combined thickness of the glass and interlayer.

Objects and advantages of this invention are further illustrated by the following examples. The particular materials and amounts thereof, as well as other conditions and details, recited in these examples should not be used to limit this invention. Unless stated otherwise all percentages, parts and ratios are by weight. Examples of the invention are numbered while comparative samples, which are not examples of the invention, are designated alphabetically.

### Examples 1-2 and Comparative Sample A

The following materials are used:
PP-1 is a low crystallinity, hetero-aryl catalyzed polypropylene having 12 percent by weight ethylene mer units and 88 percent by weight propylene units, having a refractive index as determined by the procedures of ASTM D542 of 1.48, crystallinity of 18% determined using DSC as described previously, a density of 0.8665 g/cm³, a melt flow rate of 2 g/10 min determined at 230° C. with 2.16 kg weight, Shore A hardness of 88 measured according to the procedures of ASTM 2240, flexural modulus of 4640 psi (32 MPa) measured according to the procedures of ASTM D790 commercially available from The Dow Chemical Company under the trade designation DE2300.
SLEP-1 is a polymer of 64 weight percent ethylene and 36 percent octene having a density of 0.868 g/cc (g/cm³), a refractive index of 1.48, and a melt index I₂ of 0.4 g/10 min commercially available from The Dow Chemical Company under the trade designation Engage 8150. SLEP-2 is a polymer of 78 weight percent ethylene and 22 percent butene having a density of 0.885 g/cm³, a refractive index of 1.48, and a melt index I₂ of 1.6 g/10 min commercially available from The Dow Chemical Company under the trade designation EG 7256.
Si-1 is vinyl trimethoxy silane commercially available from Dow Corning, Corp. under the trade designation Z6030.
POX-1 is 2,5-dimethyl-2,5-di(t-butylperoxy)hexane commercially available from Arkema under the trade designation Luperox 101.
ACC-1 is an accelerator, dibutyl tin dilaurate.

Method for Making Blends and Compositions Used in the Examples of the Invention and Competitive Samples:

In making blends comprising blends of ethylene alpha olefin copolymers and low crystallinity propylene polymers, pellets of each polymer are placed in a loss in weight feeders that adjusts to variations in feed of their respective pellets. These feeders supply pellets at a combined rate of 50 lb. (22.7 kg) per hour with respective rates of feed of each polymer to result in the compositions in Table 1. Pellets are supplied to a fully intermeshing twin screw extruder commercially available from Coperion Werner & Pfleiderer under the trade designation ZSK 25 Mega Compounder having 6 distributive elements and 7 kneading elements. The 25 mm screws are turned at 500 rpm with the barrel of the extruder maintained at a temperature of 190-200° C., except for the first or feed zone which has a set temperature maintained at 160 to 170° C. The extruder has barrel length of 45 times its 25 mm diameter. The polymers are extruded through a 4-hole die to produce pellets.

Reacting of vinyl functional coupling agents with polymers is accomplished in a single screw extruder used to extrude sheet. The blends prepared using the fully intermeshing twin screw extruder are imbibed with a liquid blend of coupling agent, dialkyl peroxide, and when indicated in Table 1, the indicated quantity of the indicated accelerator for the non-vinyl functionality of vinyl functional coupling agent. To facilitate addition of the silane, peroxide, and dibutyl tin dilaurate, a master cocktail is blended that consists of 2000 parts of Si-1, 100 parts of POX-1, and 5 parts of dibutyl tin dilaurate by weight. The reaction is carried out using a large excess of the vinyl functional siloxane coupling agent to the dialkyl peroxide which is used to generate free radicals to perform the grafting of the coupling agent to the polymer. Amounts are indicated in Table 1. Once the vinyl functional siloxane is reacted with the polymer or polymers, the tin in the accelerator catalyzes the crosslinking reaction in the presence of moisture.

In each Example and Comparative Sample the Formulation indicated in Table 1 is made into a film by the following procedure:

The extruded pellets are processed into films using a cast film line consisting of a 30 mm single screw extruder made by Davis Standard of Killion, N.J. The extruder has a screw with a diameter of 30 mm and a relative screw length of 24 diameters. The extruder is equipped with a flat extrusion die having an orifice 28 cm (11 inches) wide. Films of two thicknesses (12 and 16 mil (305 and 406 μm)) are produced from each formulation. The barrel of the single screw film extruder is divided into four heating zones progressively increasing the temperature of the polymer material up to the adapter, filter, and the flat die. The barrel temperature is maintained in each of zones 1-6 in the range 150.-160° C., 190-200° C., 180-220° C., 230-245° C., 240-260° C. and 240.-260° C., respectively. The temperature of the adapter is maintained at 230-260° C. The temperature of the die is maintained at 245-255° C. in the middle sections, at 255-265° C. at the both edges of the die, and at 260-270° C. at the lips of the die.

The temperatures are varied in each zone in a relatively narrow range according to the melt flow rate of the resin used. The speed of the screw is maintained at between 14-17 rpm for 0.18 mm thick films and 19-22 rpm for 0.36 mm thick films.

Each film is extruded and cooled using a three roll casting roll stock and is wound onto 7.6 cm cores. Fifteen samples are cut for testing from each film produced. At each of five sampling locations which are 10 linear feet (3 m) apart, samples are obtained at three points across the film web (from each of the edges and from the middle).

Glass Laminate Preparation

Samples of safety glass laminates are prepared as described below for use in these examples. All samples are produced using clear soda-lime-silicate glass sheets of 3 mm thickness and dimensions of 30.5×30.5 cm which are cleaned using acetone to remove dust, grease and other contaminates from the glass surface.

For laminating, a piece of film is cut to obtain a sample which is 30.5×30.5 cm. This sample is put onto the surface of the bottom glass sheet and pressed onto the glass sheet using a rubber roll. Another glass sheet is placed on top of the film obtaining a sandwich structure which is then clamped. This sandwich is placed in a laboratory press, Model 3891, manufactured by Carver, Inc., Wabash, Ind., equipped with a temperature-pressure-time control system monitored by a microprocessor. The following cycle is used to laminate the glass: heating from room temperature to 135° C. in 1 hour, holding at 135° C. and pressure 13.5 Bar for 30 minutes, slow release to normal pressure, and cooling to room temperature in 2 hours. Heating melts the film surfaces during the lamination process.

Film Testing Procedures

Without lamination, the film is tested for Peak Load, Total Energy, and Tear Strength according to the procedures of ASTM-D624, and for Internal Haze according to the procedures of ASTM-D1003. These results are reported in Table 2.

The haze is also measured after laminating 0.3 to 0.4 mm film between two layers of 3 mm thick sheets of clear, soda-lime-silicate glass. The transmission is measured using German Standard DIN R43-A.3/4ANSI Standard Z26. 1T2. The haze is measured using German Standard DIN R43-A.3/4. These results are reported in Table 3.

TABLE 1
COMPONENTS IN EACH EXAMPLE AND COMPARATIVE
SAMPLE

| | Example or | | |
|---|---|---|---|
| | sample | | |
| | | | Comparative |
| | Example 1 | Example 2 | Sample A |
| | weight | weight | weight |
| | percent | percent | percent |
| | based on | based on | based on |
| | polymers | polymers | polymers |
| PP-1 | 70 | 50 | |
| SLEP-1 | 30 | 50 | |
| SLEP-2 | | | 100 |
| Si-1 | 1.75 | 1.75 | 1.75 |
| POX-1 | 0.10 | 0.10 | 0.10 |
| ACC-1 | 0.0050 | 0.0050 | 0.0050 |
| ADD-1 | none | none | none |

*CS = Comparative Sample, not an example of the invention

Note that in C.S. A, SLEP-2 rather than SLEP-1 is chosen as a comparison with the blends of PP-1 with SLEP-1 because it represents the highest density SLEP that can be utilized and still have a chance of meeting the haze requirement.

TABLE 2
Mechanical and Optical Haze data for Examples 1 and 2 and Comparative Sample A.

| | | | | | | Tear | |
|---|---|---|---|---|---|---|---|
| Extruded film | | | | Total | | Strength | |
| (12-16 mil | | Peak | Total | Energy | Tear | in | |
| thickness) | Peak | Load | Energy, | in | Strength, | Newtons/ | Internal |
| 0.3-0.4 mm | Load, lbf | Newtons | in-lbf | Newton m | Lbf/in | meter | haze, % |
| Example 1 | 2.6 | 11.48 | 3.3 | 0.37 | 182 | 1040 | 0.3 |
| Example 2 | 3.2 | 14.10 | 6.1 | 0.68 | 197 | 1125 | 0.4 |
| Comparative | 4.3 | 18.90 | 5.7 | 0.63 | 228 | 1304 | 0.4 |
| Sample A | | | | | | | |

TABLE 3
Haze of laminates made from films listed in Table 1.

| Haze of Laminates | Haze (%) |
|---|---|
| 2 layers of plain glass | 0.37 |
| Example 1 | 0.56 |
| Example 2 | 0.85 |
| Comparative Sample A | 1.55 |

### Examples 3-8

Using the same preparation techniques as for Example 1, 6 new compounds are prepared. The goal is to define the practical performance range that could be obtained with these two part compositions. Materials are produced that are rich in SLEP-1 while others are produced that are balanced or rich in PP-1. PP-1 and SLEP-1 are first melt mixed in the ZSK25 fully intermeshing twin screw extruder operated at 500 RPM and at a feed rate of 50 pounds (22.7 kg) per hour. The feed zone of the barrel is set at 160° C., while all subsequent extruder zones are set at 200° C. The same screw stack is used as is used previously, having at least 5 kneading blocks having a combined length of 5 times the diameter of the extruder and at least 5 distributive mixing elements. The polymers are extruded through a 4-hole die to produce pellets.

The vinyl trimethoxy silane is used at two levels, 1.75% and 1.0% by weight. To make addition of the vinyl trimethoxy silane, peroxide, and dibutyl tin dilaurate easier, a master cocktail is blended that consists of 2000 parts of Si-1, 100 parts of POX-1, and 5 parts of dibutyl tin dilaurate by weight.

A sample of 40 lb (18.16 kg) of melt compounded pellets is placed in a polyethylene liner inside of a fiber drum. The required quantity of cocktail to prepare the formulation shown in Table 4 is poured on top of the pellets. The pellets are covered with a polyethylene sheet and the lid is placed on the fiber drum. The fiber drum is then placed on a tumbler and turned end over end for 30 minutes. At the end of 30 minutes, the fiber drums are removed and take over to the sheet extrusion line.

The sheet extrusion line is a 2 inch diameter single screw extruder made by Davis Standard of Killion, N.J. This extruder has 3 temperature zones. The feed is set at 160° C. and the two subsequent zones are set at 200° C. The die is also set at 200° C. The die is a 2 foot (0.6 m) wide streamlined die from EDI, Extrusion Dies Industries, L.L.C., that extrudes into the nip, that is the point at which rolls are closest together, separated by the thickness of the extruded sheet, of a 3 roll stack. The 3 roll stack cools and calibrates the sheet to the target thickness, in this case, 0.76 mm. To facilitate air removal during lamination, a textured roll with a light leather pattern is used. The draw rate of the 3 roll stack is adjusted to collect sheet that just less than 30 mils (762 μm) thick. A sheet of release film is inserted into the roll of sheet as it is wound up to ensure that blocking does not occur. The rolls of sheet are placed in foil lined bags and heat sealed.

TABLE 4
COMPONENTS IN EACH OF EXAMPLES 3-8

| | Example or sample | | | | | |
|---|---|---|---|---|---|---|
| | Example 3 | Example 4 | Example 5 | Example 6 | Example 7 | Example 8 |
| | weight percent | weight percent | weight percent | weight percent | weight percent | weight percent |
| | based on | based on | based on | based on | based on | based on |
| | polymers | polymers | polymers | polymers | polymers | polymers |
| PP-1 | 70 | 50 | 30 | 70 | 50 | 30 |
| SLEP-1 | 30 | 50 | 70 | 30 | 50 | 70 |
| SLEP-2 | | | | | | |
| Si-1 | 1.75 | 1.75 | 1.75 | 1.0 | 1.0 | 1.0 |
| POX-1 | 0.10 | 0.10 | 0.10 | 0.05 | 0.05 | 0.05 |
| ACC-1 | 0.0050 | 0.0050 | 0.0050 | 0.0025 | 0.0025 | 0.0025 |

Laminates of 12″×12″ (0.3 m×0.3 m) are prepared by manually sandwiching 0.7-0.8 mm of interlayer film between two sheets of plain glass of 3 mm thickness each at the following conditions in a compression molding press:

Preheat to 130° C. for 5 min

Application of pressure in a sequence of 2500 lb force (11120 N) for 2 min, 5,000 lb force (22240 N) for 5 min, 7500 lb force (33360 N) for 2 min, and 10,000 lb force (44480 N) for 5 minutes

Removal from the compression molder followed by air cooling on a lab bench for 30 min.

The ball drop impact test is conducted according to ANSI/SAE Z26.1-5.12 standard except that only 5 specimens are tested. Prior to testing the specimens to be tested are stored at 21° C. for 4 h. Each laminate is placed on a steel frame so that it is substantially horizontal at the time of impact. A 225 g solid steel spherical ball with diameter of 38 mm is dropped from a predetermined height once, freely and from rest, striking the specimen within 1″ (2.54 cm) of the center.

The impact produces large number of cracks in the glass. According to ANSI/SAE Z26.1-5.12.3, the fractured laminates are analyzed by the following criteria:

(1) Not more than two of the 12 specimens tested for each type and height shall break into separate large pieces.
(2) Furthermore, with no more than two of the remaining specimens shall the ball produce a hole or a fracture at any location in the specimen through which the ball will pass.
(3) At the point immediately opposite the point of impact, small fragments of glass may leave the specimen, but the small area thus affected shall expose less than 1 in² (2.45 cm²) of the reinforcing or the strengthening material, the surface of which shall always be covered with tiny particles of tightly adhering glass. Total separation of glass from the reinforcing or strengthening material shall not exceed 3 in² (19.35 cm²) on either side.
(4) Spalling of the outer glass surface opposite the point of impact and adjacent to the area of impact is not to be considered failure.

Examples of glass laminates prepared from the films of Examples 3-8, having the compositions indicated in Table 4, are tested according to the preceding procedure at three different heights, that is, 5, 8 and 9.14 m. In addition, a control sample based on PVB as the interlayer film is also tested as Comparative Sample B. The test results are listed in Table 5. All samples pass the ball drop test at 5 m with a 225 g ball at ambient conditions. Examples 3, 4 and 5 with the higher level of grafting all pass at 8 m, and the highest PP-1 content blend with the lower grafting level also passes at 8 m. At 9.14 m, Example 3 passes the test with a success rate of 80%. The rest of the blends do not pass. The PVB based laminates pass the ball drop impact test at both 8 and 9.14 m.

TABLE 5
Results of the Ball Drop Impact Testing

| Example (Ex) or | | |
|---|---|---|
| Comparative | Ball Drop | |
| Sample (CS) | at 8 m | Ball drop at 9 m |
| Ex 3 | 100% Pass | 80% Pass |
| Ex 4 | 100% Pass | 50% Pass |
| Ex 5 | 100% Pass | 50% Pass |
| Ex 6 | 100% Pass | 50% Pass |
| Ex 7 | 20% Pass | NM |
| Ex 8 | 40% Pass | NM |
| CS B | 100% Pass | 100% Pass |

NM: Not Measured

### Examples 9-14 and Comparative Sample C

Materials used for Examples 9-13 and Comparative Sample C:

PP-1 as previously described
TIE-1 is an ethylene vinyl acetate copolymer having 18 weight percent vinyl acetate, a density of 0.94 g/cm³, and a melt index I₂ of 8 commercially available from DuPont under the trade designation Elvax 3174.
TIE-2 is an ethylene vinyl acetate copolymer having 12 weight percent vinyl acetate, a density of 0.93 g/cm³, and a melt index I₂ of 8 commercially available from DuPont under the trade designation Elvax 3134.
TIE-3 is a zinc salt of a poly(ethylene-co-methacrylic acid) ionomer having a density of 0.95 g/cm³, and a melt index I₂ of 5.5 commercially available from DuPont under the trade designation Surlyn 1705.
TIE-4 is a sodium salt of a poly(ethylene-co-methacrylic acid) ionomer having a melt index I₂ of 4.3 commercially available from DuPont under the trade designation Surlyn 1802.

A monolayer film of PP-1 in Comparative Sample C is prepared by supplying pellets of each to a cast film line consisting of three 25 mm single screw extruders made by Davis Standard Killion Business Group. Two outside extruders are set to zero rpm, and a center extruder with a relative screw length of 24 diameters was run to make monolayer film. A cast film line is equipped with a flat extrusion die having an orifice 28 cm (11 inches) wide. The barrel of the single screw film extruder is divided into three heating zones progressively increasing the temperature of the polymer material up to the adapter, filter, and the flat die. The barrel temperature is maintained in a succession of temperatures from 104 to 210° C. The temperature of the die is maintained at 190° C.

The temperatures are varied in each zone in a relatively narrow range according to the melt flow rate of the resin used. The speed of the screw is maintained at 121.6 revolutions per minute to prepare 0.4 mm thick films. The draw rate of a chill roll is adjusted to collect sheet that is 10 mil (0.25 mm) thick. The film is extruded and cooled using a chill roll at 13° C. to quench the film and reduce the stickiness of the films. The resulting film has a discernable tackiness, but insufficient to result in back up of extrudate onto the chill roll. A sheet of release film is inserted into the roll of sheet as it is wound onto cores to ensure that blocking does not occur.

The combinations of TIE and PP films indicated in Table 6 are prepared by multilayer coextrusion using 3 extruders commercially available from Davis Standard Killion Business Group under the trade designation KTS 100 and one under the trade designation KTS 100 (each 1″ (2.54 cm) in diameter), with a 11″ (27.9 cm) coat hanger type die and slot type feedblock. The center extruder has three heating zones which are set to 238° F. (114° C.), 360° F. (182° C.) and 390° F. (200° C.), respectively for zones 1, 2 and 3. In addition, the transfer lines, feedblock and die are set at 410° F. (210° C.). The two tie layer extruders have three heating zones which are set to 320° F. (160° C.), 350° F. (177° C.) and 360° F. (182° C.), respectively for zones 1, 2 and 3. In addition, the transfer lines, feedblock and die are set at 360° F. (181° C.). The polymers are extruded onto a chill roll temperature at 55° F. (13° C.), to promote rapid quenching, enhance film optics, and reduce adhesion to the chill roll. At least 50 linear feet (15 m) of the coextruded film is collected and stored for property characterization. A desired thickness as indicated in Table 6 with about 80% of the total thickness (or about 0.4 mm) being PP-1 as indicated in Table 6 is achieved by running the center extruder at 119.8 rpm and the tie extruders at 25.7 and 21.2 rpm.

Total haze as well as internal haze of the mono and multilayer coextruded films is measured on a haze measuring instrument commercially available from BYK Gardner under the trade designation BYK Gardner Haze-gard based on ASTM D 1003 Procedure A. For the measurement of internal haze, mineral oil is applied to the film surface to minimize the contribution arising from the roughness on the film surface.

TABLE 6
Optical Properties of Interlayer Films

| | | | | | | stdev, | stdev, | | | | stdev |
|---|---|---|---|---|---|---|---|---|---|---|---|
| | | | | Thickness, | Thickness | thickness, | thickness, | | stdev | Internal | Internal |
| # | Skin | core | skin | mil | mm | mil | mm | Haze % | haze % | Haze % | Haze % |
| CS C | | PP-1 | | 10.0 | 0.25 | 0.66 | 0.017 | 11.0 | 0.5 | 1.39 | 0.11 |
| EX 9 | TIE-1 | PP-1 | TIE-1 | 14.3 | 0.36 | 0.14 | 0.0035 | 5.6 | 0.4 | 2.85 | 0.31 |
| EX 10 | TIE-1 | PP-1 | TIE-1 | 15.1 | 0.38 | 0.17 | 0.0043 | 17.0 | 2.0 | 2.20 | 0.22 |
| EX 11 | TIE-2 | PP-1 | TIE-2 | 14.6 | 0.37 | 0.53 | 0.013 | 14.4 | 0.5 | 2.31 | 0.47 |
| EX 12 | TIE-3 | PP-1 | TIE-3 | 15.0 | 0.38 | 0.52 | 0.013 | 15.1 | 2.1 | 2.27 | 0.23 |
| EX 13 | TIE-4 | PP-1 | TIE-4 | 16.1 | 0.40 | 0.61 | 0.015 | 14.6 | 0.6 | 2.65 | 0.32 |

The data in Table 6 illustrates a low crystallinity propylene polymer adhered to glass using various tie layers and shows that the tie layers can increase or decrease haze over that of the low crystallinity propylene polymer alone. Increases in haze are believed to be attributable at least partially to a mismatch in effective refractive indices of the low crystallinity propylene polymer and tie layers or tie layers and glass or to increased crystal size in the interlayer. In the practice of the invention it is frequently preferred that the tie layers and interlayer have refractive indices within the same tolerances as those of components of the interlayer.

Embodiments of the invention include the following:
1. A film, useful as an interlayer, that is an interlayer film, comprising a polymer composition obtainable from (a) at least one low crystallinity propylene polymer, and at least one (b) internal adhesion enhancer, (c) at least one clarity enhancer or (d), more preferably, both (b) and (c).
2. A polymer composition, useful to make the film, obtainable from (a) at least one low crystallinity propylene polymer, and at least one (b) internal adhesion enhancer, (c) at least one clarity enhancer or (d), more preferably, both (b) and (c), preferably wherein at least one clarity enhancer is at least one clarifying polymer.
3. A laminate comprising the film of Embodiment 1 and at least one first rigid or optically transparent substrate or combination thereof.
4. A laminate comprising at least one optically transparent substrate, preferably glass, more preferably mineral glass, having a refractive index and at least one optically transparent film comprising at least one olefin polymer, preferably wherein at least about any of 50, 55, 60, 65, 70, 75, 80, 85, 90, 95 or 99 percent of the polymers in the optically transparent film or films of the laminate are olefin polymers, preferably selected from propylene polymers, ethylene polymers, butene polymers, or combinations thereof, more preferably comprising at least one propylene polymer, wherein the difference between the refractive index of the substrate and (a) the refractive indices of each of the polymers in the film or films, (b) the refractive index of each film in the laminate, or (c) a combination thereof is at most about any of 0.01, 0.03, 0.05, 0.1 or 0.2.
5. The laminate of embodiment 4 wherein the laminate includes at least one tie layer and at least one interlayer film and the difference between the refractive index of the substrate and (a) the refractive indices of each of the polymers in the tie layer and in the interlayer film, (b) the refractive index of the tie layer and interlayer, or (c) a combination thereof is at most about any of 0.01, 0.03, 0.05, 0.1 or 0.2.
6. A laminate of Embodiment 3, 4 or 5 wherein there is a second substrate adjacent the film on the side of the film opposite that of the first substrate.
7. The laminate of Embodiment 6 wherein the first substrate is transparent and the second substrate is transparent, light absorptive or light reflective or a combination thereof.
8. The laminate of any of embodiments 3 through 7 wherein at least one substrate, preferably both substrates independently comprise at least one member of the group consisting of mineral or polymer glass, polystyrene, polyethylene terephthalate, poly(4-methyl-1-pentene), acrylic polymers, fiber glass, silicone layers, polycarbonate sheets, polyurethane layers, and combinations thereof.
9. An article comprising at least one composition of embodiment 2, film of embodiment 1, laminate of any of embodiments 3 through 8 or a combination thereof.
10. The laminate, article, film or composition of any of the preceding embodiments wherein the polymer composition is at least about any of 85, 90, or 95 weight percent of the composition, film or interlayer film of the laminate or article, the remainder comprising additives.
11. The laminate, article, film or composition of any of the preceding embodiments wherein at least one, preferably each low crystallinity propylene polymer independently is a polymer having at least about any of 50, 51, 60, 70, 80, or 90 weight percent propylene (mer units) and the remainder at least one alpha-olefin different from propylene, preferably ethylene (mer units), which is more preferably present in an amount of from at least about 8, 9, 10, or 11 optionally to at most about any of 15, 20, 25, or 30 weight percent.
12. The laminate, article, film or composition of any of the preceding embodiments wherein at least one, preferably each, low crystallinity propylene polymer independently has advantageously at least one of, more advantageously at least 2, preferably at least 3, more preferably at least 4, and in one embodiment, most preferably at least 5 of the following:
   (a) a melt flow rate of from at least about any of 0.5, 1.0, or 1.5 to at most about any of 5, 10, or 20 g/10 minutes:
   (b) a crystallinity of less than about any of less than about 47 percent, at most about 34 percent, at most about 24 percent, or at most about 18 percent as determined by DSC;
   (c) a molecular weight distribution of at most about 4, preferably at most about 3.5, more preferably at most about 3;
   (d) a narrow crystallinity distribution, preferably wherein at least about 75, more preferably at least about 85 weight percent of the polymer is isolated in one or two adjacent soluble fractions by thermal fractionation with 7 to 8° C. separation in the fractions and wherein each of these fractions has a weight percent ethylene content preferably within at most about 20, more preferably within at most about 10 weight percent of the average weight percent of ethylene in the low crystallinity propylene polymer; or
   (e) a heat of fusion of at most about any of 80, 60, 40, 30, 35, 25, 15, 10 or 6 J/g and preferably at least about 1 or 2 J/g.
13. The laminate, article, film or composition of any of the preceding embodiments wherein at least one, preferably each, low crystallinity propylene polymer is a single site or heteroaryl-catalyzed propylene polymer, preferably single site catalyzed in one embodiment and preferably heteroaryl-catalyzed in another embodiment or combination thereof.
14. The laminate, article, film or composition of any of the preceding embodiments wherein at least one, preferably each clarity enhancer is independently selected from an integral clarity enhancer, a clarifying polymer, a coupling agent, a crosslinking agents or combination thereof.
15. The laminate, article, film or composition of any of the preceding embodiments wherein each adhesion enhancer is selected from external adhesion enhancers, internal adhesion enhancers and combinations thereof, preferably at least one tie layer, at least one primer, at least one surface treatment, at least one coupling agent, at least one crosslinking agent, or combination thereof.
16. The laminate, article, film or composition of any of the preceding embodiments wherein at least one adhesion enhancer is at least one tie layer selected from compositions comprising at least one polymer selected from at least one EVA, at least one EMA, at least one EMAC, at least one m-PE, at least one PVB, at least one PVC, at least one polyolefin grafted with maleic anhydride or a combination thereof, preferably at least one polymer selected from at least one EVA, at least one EMA, at least one EMAC, at least one m-PE, at least one PVC, at least one polyolefin grafted with maleic anhydride or a combination thereof, more preferably at least one polymer selected from at least one EVA, at least one EMA, at least one EMAC, at least one m-PE, at least one polyolefin grafted with maleic anhydride or a combination thereof.
17. The laminate, article, film or composition of any of the preceding embodiments comprising at least one coupling agent, preferably selected from the group consisting of silanes, siloxanes, titanates, and combinations thereof, more preferably from the group consisting of vinyl-triethoxy-silane, amino-propyl-triethoxysilane, and combinations thereof.
18. The laminate, article, film or composition of any of the preceding embodiments comprising at least one coupling agent present in an amount of from at least about any of 0.5, 1, 1.2, 1.4, or 1.6 to at most about any of 2, 2.5, or 3 weight percent based on weight of polymer composition.
19. The laminate, article, film or composition of any of the preceding embodiments comprising at least one, preferably 2 of at least one crosslinking agent, at least one free radical initiator, or at least one accelerator for a coupling agent.
20. The laminate, article, film or composition of any of the preceding embodiments substantially free of a nucleating agent.
21. The laminate, article, film or composition of any of the preceding embodiments comprising at least one clarifying polymer wherein the polymer is an olefin polymer, preferably selected from at least one ethylene polymer, at least one polybutene, at least one atactic polypropylene or at least one poly(4-methyl-1-pentene) or combination thereof, more preferably at least one ethylene polymer having a density less than about 0.915 g/cm³, most preferably at least one ethylene polymer selected from VLDPE, ULDPE, substantially linear ethylene polymers, and metallocene catalyzed ethylene polymers.
22. The laminate, article, film or composition of any of the preceding embodiments wherein the clarifying polymer comprises from at least about any of 10, 15, 20, 30, 35, or 40 to at most about 45, 50, 60, 65, 75 or 80 weight percent of the polymer composition.
23. The laminate, article, film or composition of any of the preceding embodiments wherein the difference in refractive index between at least one low crystallinity propylene polymer and that of at least one other polymer present, preferably between the that of the low crystallinity propylene polymer and each other polymer present is at most about any of 0.01, 0.03, 0.05, 0.1 or 0.2.
24. The laminate, article, film or composition of any of the preceding embodiments wherein the difference in density between at least one low crystallinity propylene polymer and the density of at least one other polymer present, preferably between the density of the low crystallinity propylene polymer and the density of each other polymer present is at most about any of 0.5, 0.3, or 0.2 g/cm³.
25. The laminate, article, film or composition of any of the preceding embodiments wherein the film, a film comprising the composition, at least one interlayer film from the laminate or article, has at least one, advantageously 2, preferably 3, more preferably 4, most preferably 5, of the following properties:
   (a) an internal haze of at most about any of 0.25, 0.5, 1, 2, 5, or 10 percent as determined by ASTM D1003;
   (b) a T peel of at least about any of 0.1, 0.3, 0.5 to at most about any of 1, 2, or 4 N/mm;
   (c) a total energy as determined by the procedures of D624 of at least about any of 0.3, 0.4, 0.5, 0.6, or 0.65 Nm;
   (d) an elastic modulus of from about 173 to about 207 MPa; or
   (e) a tan delta of from about 0.1 to 0.6.
26. The laminate, article, film or composition of any of the preceding embodiments wherein the laminate or article or a laminate of the film, or of a film comprising the composition, has at least one, advantageously 2, preferably 3, more preferably at least 4, most preferably at least 5 of the following properties:
   (a) a haze of at most about any of 0.6, 1, 2, 3, 6, or 11 percent;
   (b) transmission of visible light of at least about any of 70, 75, 80, 85, 90, or 95 percent;
   (c) a difference in refractive index of between at least one, preferably 2, optically transparent substrates or tie layers and at least one interlayer film, between at least one tie layer and at least one substrate, or a combination thereof of at most about any of 0.01, 0.03, 0.05, 0.1 or 0.2;
   (d) passes penetration test ANSI/SAE Z26.1-5.12 of at least any of 5, 8 or 9 m or
   (e) is an acoustic barrier.
27. The laminate, article, film or composition of any of the preceding embodiments wherein the film, a film comprising the composition, at least one interlayer film from the laminate or article, has or had at before lamination a smooth, patterned, embossed, roughened, printed, or treated surface or combination thereof.
28. The laminate, article, film or composition of any of the preceding embodiments wherein the film, a film comprising the composition, at least one interlayer film from the laminate or article, has or had at before lamination a thickness of from at least about any of 0.1, 0.15, 0.2. 0.25, 0.3, 0.4. mm, optionally to at most about any of 0.75, 1, 2, or 5 mm.
29. A laminate of any of the preceding embodiments having a configuration selected from where the interlayer film of the invention is represented by F, glass by G, tie layers by T, other polymers by P and electronics such as solar cells, liquid crystal displays, memory cells and the like by E exemplary combinations include: G/F, G/T/F, P/F, P/T/F, E/F, E/T/F, G/F/G, G/T/F/G, P/F/G, P/T/F/G, E/F/G, E/T/F/G, G/F/T/G, G/T/F/T/G, P/F/T/G, P/T/F/T/G, E/F/T/G, E/T/F/T/G, G/F/P, G/T/F/P, P/F/P, P/T/F/P, E/F/P, E/T/F/P, G/F/T/P, G/T/F/T/P, P/F/T/P, P/T/F/T/P, E/F/T/P, E/T/F/T/P, G/F/G/F/G, G/F/P/F/G, G/T/F/T/G/T/F/T/G, G/T/F/T/P/T/F/T/GP/F/, P/T/F/E, P/T/F/T/E, E/F/P/F/G, E/T/F/T/G, G/F/P/P/G, G/F/P/P/F/P, G/T/F/P/P/P/P, G/T/F/P/T/P/F/P/P, and variations thereof, particularly where there are two or more directly adjacent layers in the same category such as two or more directly adjacent layers of the interlayer film of the invention, G/F/F/G, G/T/F/F/T/G or a combination thereof.
30. An article of any of the preceding embodiments which is at least one of the following: safety glass, side window glazing, windshields, windscreens, protective shields, bullet resistant glass, windows, green houses, photovoltaic cells, panels or sheeting for greenhouses or screens for electronics such as televisions or other viewing screens, hurricane glass, protective cover sheets for articles such as TV or computer screens, windows or skylights of large tents, jet windshields, and combinations thereof,
31. A process of preparing a film comprising (a) supplying at least one first component, a low crystallinity propylene polymer, (b) supplying at least one second component, selected from at least one an internal adhesion enhancer, at least one clarity enhancer or a combination thereof; and, (d) admixing the first and second components and optional additives.
32. The laminate, article, film or composition of any of the preceding embodiments comprising at least one coupling agent
33. The process of embodiment 30 wherein the step of (d) admixing involves at least 2 different mixing elements selected from conveying elements, reversing elements, and kneading elements.
34. A process of making a laminate comprising steps of (a) positioning at least one layer of the interlayer film directly adjacent to at least one layer of substrate (b) applying sufficient heat or other energy to result in softening of the interlayer directly adjacent the substrate with simultaneous application of sufficient pressure to press polymer into intimate contact with substrate.
35. The process of embodiment 33 wherein the pressure is applied for less than about any of 30, 20, 15, 10, or 5 minutes, heat is supplied for periods of less than about any of 60, 45, 30, 20, or 15 minutes, or a combination thereof.
36. The process of embodiment 33 or 34 wherein there is an additional step (c) of cooling the resulting laminate to ambient temperature.

1. A film, useful as an interlayer comprising a polymer composition obtainable from (a) at least one low crystallinity propylene polymer, and at least one (b) internal adhesion enhancer, (c) at least one clarity enhancer or (d) both (b) and (c).

2. The film of claim 1 wherein the low crystallinity propylene polymer has a crystallinity of less than about 47 percent as determined by DSC.

3. The film of claim 1 wherein the low crystallinity propylene polymer comprises at least about 70 weight percent propylene mer units and at least about 6 weight percent ethylene mer units.

4. The film of claim 1 wherein the low crystallinity propylene polymer is a heteroaryl-catalyzed propylene polymer or a single site catalyzed propylene polymer.

5. The film of claim 1 wherein the low crystallinity propylene polymer has at least one of the following properties:
(a) a molecular weight distribution of at most about 4;
(b) a narrow crystallinity distribution wherein at least about 75 weight percent of the polymer is isolated in one or two adjacent soluble fractions by thermal fractionation with 7 to 8° C. separation in the fractions and wherein each of these fractions has a weight percent ethylene content within at most about 20 weight percent of the average weight percent of ethylene in the low crystallinity propylene polymer; or
(c) a heat of fusion of from at least about 1 to at most about any of 80 J/g.

6. The film of claim 4 wherein the adhesion enhancer comprises at least one tie layer.

7. The film of claim 4 wherein at least one adhesion enhancer or clarity enhancer comprises at least one coupling agent.

8. The film of claim 1 comprising at least one low crystallinity and at least one polymer selected from alpha olefin polymers, hereinafter referred to as a clarifying polymer.

9. The film of claim 8 wherein the clarifying polymer comprises at least one polymer selected from at least one ethylene polymer, at least one polybutene, at least one atactic polypropylene or at least one poly(4-methyl-1-pentene) or combination thereof.

10. The film of claim 8 also comprising at least one coupling agent.

11. A laminate comprising the film of claim 1 and at least one substrate.

12. The laminate of claim 11 wherein at least one substrate is optically transparent or rigid or a combination thereof.

13. A process of preparing a film comprising (a) supplying at least one first component, a low crystallinity propylene polymer, (b) supplying at least one second component, selected from at least one an internal adhesion enhancer, at least one clarity enhancer or a combination thereof; and, (d) admixing the first and second components and optional additives.

14. The process of claim 13 wherein step (d) admixing comprises both distributive mixing and dispersive shear.

15. A process of making a laminate comprising steps of (a) positioning at least one layer of the interlayer film directly adjacent to at least one layer of substrate (b) applying sufficient heat or other energy to result in softening of the interlayer directly adjacent the substrate with simultaneous application of sufficient pressure to press polymer into intimate contact with the substrate.

16. A laminate comprising at least one optically transparent substrate having a refractive index and at least one optically transparent film containing at least one olefin polymer, wherein the difference between the refractive index of the substrate and (a) the refractive indices of each of the polymers in the film or films, (b) the refractive index of each film in the laminate, or (c) a combination thereof is at most about 0.05.

17. The film of claim 2 wherein the low crystallinity propylene polymer comprises at least about 70 weight percent propylene mer units and at least about 6 weight percent ethylene mer units.

18. The film of claim 2 wherein the low crystallinity propylene polymer is a heteroaryl-catalyzed propylene polymer or a single site catalyzed propylene polymer.

19. The film claim 2 wherein the low crystallinity propylene polymer has at least one of the following properties:
(a) a molecular weight distribution of at most about 4;
(b) a narrow crystallinity distribution wherein at least about 75 weight percent of the polymer is isolated in one or two adjacent soluble fractions by thermal fractionation with 7 to 8° C. separation in the fractions and wherein each of these fractions has a weight percent ethylene content within at most about 20 weight percent of the average weight percent of ethylene in the low crystallinity propylene polymer; or
(c) a heat of fusion of from at least about 1 to at most about any of 80 J/g.

20. The film claim 3 wherein the low crystallinity propylene polymer has at least one of the following properties:
(a) a molecular weight distribution of at most about 4;
(b) a narrow crystallinity distribution wherein at least about 75 weight percent of the polymer is isolated in one or two adjacent soluble fractions by thermal fractionation with 7 to 8° C. separation in the fractions and wherein each of these fractions has a weight percent ethylene content within at most about 20 weight percent of the average weight percent of ethylene in the low crystallinity propylene polymer; or
(c) a heat of fusion of from at least about 1 to at most about any of 80 J/g.
